(19) United States
(12) Patent Application Publication
(10) Pub. No.: US 2026/0227950 A1
(43) Pub. Date: Aug. 6, 2026

(54) METHODS AND APPARATUS FOR MIPI SOUNDWIRE INTEGRATION

(71) Applicant: Intel Corporation, Santa Clara, CA (US)

(72) Inventor: Aruni NELSON, Rocklin, CA (US)

(21) Appl. No.: 19/630,525

(22) Filed: Mar. 27, 2026

(51) Int. Cl. G06F 3/16; G06F 13/38; G06F 13/42

(52) U.S. Cl. CPC G06F 3/162; G06F 13/382; G06F 13/4282; G06F 2213/0042

(57) ABSTRACT

An apparatus including: a USB Type-C interface comprising a plurality of signal pins; and an audio bus controller coupled to the USB Type-C interface, wherein the audio bus controller is configured to: transmit and receive signals according to an audio bus protocol on at least one signal pair of the plurality of signal pins to communicate with an audio bus device coupled to the USB Type-C interface.

### BACKGROUND

Modern computing platforms, including personal computers, laptop computers, tablet computers, and mobile handsets, incorporate audio subsystems that interact with audio peripheral devices to provide audio input and output functionality. Audio subsystems in computing platforms, mobile devices, and wearable electronics rely on dedicated physical interfaces to connect audio bus controllers to audio peripherals such as codecs, amplifiers, and microphone arrays.

Audio bus protocols define their own physical layer requirements, specifying dedicated pin assignments, signal types, and transceiver hardware. At the same time, platform design across the computing and mobile industries has progressively consolidated external and internal connectivity around a small number of versatile, high-pin-count connector standards capable of carrying data, power, and multimedia signals over a shared physical interface. This convergence creates increasing demand to carry audio bus traffic over connector interfaces that were originally designed for general-purpose data transfer and power delivery, rather than over dedicated audio bus pins and connectors.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 illustrates an example block diagram of a system in accordance with various aspects described herein;

FIG. 3 illustrates an example block diagram of a system in accordance with various aspects described herein;

FIG. 4 illustrates example pin mapping options;

FIG. 5 illustrates an example system in accordance with various aspects described herein;

FIG. 6 illustrates example pin mapping options;

FIG. 7 illustrates an example system in accordance with various aspects described herein;

FIG. 8 illustrates example pin mapping options;

FIG. 9 illustrates an example system in accordance with various aspects described herein;

FIG. 10 illustrates an example message sequence for USB PD negotiation;

FIG. 11 illustrates an example system in accordance with various aspects described herein;

FIG. 12 illustrates an example system in accordance with various aspects described herein;

FIG. 13 shows an example of a method;

FIG. 14 shows an example of a method.

### DESCRIPTION

The present disclosure relates to electronic devices and interfaces for audio data communication, and more particularly to apparatus and methods for routing audio bus signals over connector interfaces of computing and mobile platforms.

Audio peripheral devices include, but are not limited to, audio codecs, digital microphone assemblies, audio amplifiers, and speaker drivers. Platform designers seeking to connect audio bus peripherals through such consolidated connector interfaces face a choice between two approaches, which may involve i) providing dedicated audio bus pins and connectors alongside the general-purpose connector, which increases board area, routing complexity, and connector count; or ii) reusing existing signal pins of the general-purpose connector for audio bus communication. The latter approach presents several technical challenges. Audio bus protocols that use single-ended signaling that can be incompatible at the signal level with connector pins designed for differential signaling, requiring active signal conversion. Reusing connector pins for audio bus communication further requires a mechanism to allocate specific pins to the audio bus function and to negotiate that allocation between connected devices. Additionally, a mechanism may be required to detect the audio bus capabilities of a peripheral connected through the general-purpose connector and to configure the audio bus communication path accordingly. It is according desirable to address these challenges in a unified manner for audio bus peripherals connected through a general-purpose connector interface.

The Universal Serial Bus (USB) has become the dominant general-purpose interface in computing and mobile platforms, providing a unified physical medium for data transfer, power delivery, and alternate mode signaling. The current physical connector standard, USB Type-C, features a reversible 24-pin connector with a defined set of signal pins. These signal pins include two transmit differential pairs (TX1+/TX1− and TX2+/TX2−), two receive differential pairs (RX1+/RX1− and RX2+/RX2−), a USB 2.0 data pair (D+/D−), two sideband use pins (SBU1 and SBU2), two configuration channel pins (CC1 and CC2), power supply lines (VBUS), and ground contacts. The USB Type-C connector thus provides a plurality of signal pins across several functional categories, each with defined electrical characteristics and assigned roles within the USB specification.

USB Power Delivery (USB PD) is a protocol that operates over the CC pins of the USB Type-C interface and manages power role negotiation and alternate mode signaling between connected devices. Alternate modes allow non-USB protocols to be carried over USB Type-C signal pins following successful USB PD negotiation between a host device and a connected peripheral. Existing alternate modes include, for example, DisplayPort Alternate Mode and Thunderbolt Alternate Mode, which repurpose the high-speed differential pairs for video and data transport respectively. No alternate mode currently exists for audio bus protocols such as those defined by the MIPI Alliance.

The MIPI Alliance defines audio bus protocols for audio data transport in embedded systems. The MIPI SoundWire protocol (referred to hereinafter as "SoundWire") is a serial interface originally designed for embedded audio systems, including a dedicated clock pin and one or more dedicated data pins, all operating with single-ended signaling, at clock rates up to 12.288 MHz. The MIPI SoundWire I3S protocol (referred to hereinafter as "SWI3S") is a newer MIPI Alliance protocol supporting both a single-ended physical layer, including a clock signal and a data signal, and a differential low-voltage physical layer, including a Data+ signal and a Data− signal, with data rates up to approximately 76 Mbps. Both SoundWire and SWI3S are designed for embedded audio systems and, in existing implementations, require dedicated transceiver hardware and physical pins separate from any USB Type-C connectivity.

The apparatuses and methods of this disclosure may utilize or be related to USB technologies. While some examples may refer to specific USB technologies, the examples provided herein may be similarly applied to various other interfaces for communicating audio data, both existing and not yet formulated, particularly in cases where such interface technologies share similar features as disclosed regarding the following examples. Various exemplary USB technologies that the apparatuses and methods described herein may utilize include operations in accordance with various USB specifications including, but are not limited to: USB 2.0 specification (08/10/2021), USB 2.0 Cable and Connector Class Document (01/08/2007), any USB 3.x base specification such as USB 3.2 rev 1.1 (03/06/2022), USB Power Delivery Specification (20/04/2023), USB Type-C Connector Specification Release 2.2 (18/10/2022), USB Type-C and Power Delivery Source Power Requirements (24/05/2021), USB Type-C Bridge Specification (23/10/2018), USB Type-C Locking Connector Specification (09/03/2016), USB4 Specification (28/10/2022) and other existing, developing, or future interface technologies. It is to be noted that aspects may be implemented in accordance with any version of the listed specifications other than the listed ones for which publication dates are provided.

The MIPI SoundWire protocol is an audio interconnect standard defined by the MIPI Alliance for use in embedded audio systems within mobile and personal computer platforms. MIPI SoundWire uses a synchronous bus including a clock line that carries a clock signal from the manager device to one or more peripheral devices, and one or more data lines that carry audio and control information. The MIPI SoundWire protocol defines a manager entity that controls the bus and one or more target peripheral entities that respond to commands from the manager entity. MIPI SoundWire supports multi-drop bus configurations in which multiple peripheral devices share a common set of signal lines connected to the manager entity. The MIPI SoundWire protocol is used in embedded audio systems to transport audio payload data, such as pulse-code modulation audio samples, and control data, such as register read and write commands and interrupt notifications, between the manager entity and the connected audio peripheral devices.

The MIPI SoundWire I3S protocol, referred to herein as SWI3S, is a newer audio interconnect standard defined by the MIPI Alliance. SWI3S is characterized as a two-pin, multi-drop, half-duplex interconnect. SWI3S carries both audio payload data, including audio streams such as pulse-code modulation audio samples, and control data, including configuration commands, register access operations, and status information, on a single link. SWI3S supports both single-ended and differential physical-layer variants. In the single-ended variant, referred to as the forwarded-bit-clock single-ended PHY, the two-pin interface includes a clock line carrying a forwarded bit clock signal from the manager to the peripheral devices as a single-ended signal, and a data line carrying a data signal as a single-ended signal shared between the manager and the peripheral devices. In the differential variant, referred to as the differential low-voltage PHY, the two-pin interface includes a differential pair of lines carrying a differential signal, providing improved electromagnetic compatibility performance suitable for system designs where signal integrity is a primary constraint. SWI3S supports multi-drop configurations in which up to twelve peripheral devices share a common physical connection to the manager entity. The half-duplex operation of SWI3S means that transmission from the manager to peripheral devices and reception from peripheral devices to the manager occur alternately on the shared physical connection, with the manager coordinating access to the shared medium.

The apparatuses and methods of this disclosure may utilize or be related to MIPI Alliance audio interconnect technologies. While some examples may refer to specific MIPI Alliance audio interconnect technologies, the examples provided herein may be similarly applied to various other audio bus interfaces, both existing and not yet formulated, particularly in cases where such interface technologies share similar features as disclosed in the following examples. Various exemplary MIPI Alliance audio interconnect technologies that the apparatuses and methods described herein may utilize include operations in accordance with various MIPI Alliance specifications including, but not limited to: MIPI SoundWire Specification Version 1.2 or Version 1.3 (September 2025), MIPI SoundWire Device Class for Audio Specification Version 1.1 (July 2025), MIPI SoundWire I3S Specification Version 1.0 (September 2025), and other existing, developing, or future audio interconnect interface technologies defined by the MIPI Alliance or other standards bodies. It is to be noted that aspects may be implemented in accordance with any version of the listed specifications other than the listed ones for which version numbers or publication dates are provided.

As used herein, the term "USB Type-C interface" may refer to the physical connector and its associated pin assignments according to the USB Type-C specification, including the plurality of signal pins as described herein. The term "signal pair" may refer to a pair of pins in the USB Type-C interface that together carry a differential signal, such as TX1+/TX1−, or that each carry a respective single-ended signal, such as D+ and D− when used individually. A signal pair may be selected from one or more of the transmit differential pairs, the receive differential pairs, the USB 2.0 data pair, or the sideband use pins of the USB Type-C interface.

As used herein, the term "audio bus controller" may refer to a circuit or functional block on a host device that manages audio bus protocol communication, including generating clock signals, framing data, and controlling one or more audio bus peripherals. The term "audio bus peripheral circuit" refers to a circuit or functional block on a peripheral device that responds to audio bus protocol communication from a host device, including receiving clock signals and transmitting and receiving audio data. In some implementations, an audio bus controller may be referred to as a SoundWire Manager or a SWI3S Manager, noting that these terms are used as equivalent to "audio bus controller".

As used herein, the term "audio bus protocol" refers to any protocol for transporting audio control and data signals between an audio bus controller and one or more audio bus peripheral circuits over a bus. The audio bus protocol may employ single-ended signaling, in which each signal is referenced to a common ground, or differential signaling, in which each signal is carried on a pair of conductors of equal magnitude and opposite polarity. Audio bus protocols described herein include, without limitation, the SoundWire protocol and the SWI3S protocol, as well as other protocols capable of being mapped to signal pairs of a USB Type-C interface.

As used in this description, the term "host apparatus" or "host device" refers to a device including an audio bus controller and acting as a bus manager or master in the audio bus protocol. A host apparatus may be, for example, a computing platform, a smartphone, a tablet, or a system-on-chip. The term "audio bus device" refers to a device including an audio bus peripheral circuit and acting as a peripheral or target in the audio bus protocol. An audio bus device may be, for example, an audio codec, an audio amplifier, a microphone array, a speaker, or a wearable audio device. The term "audio bus peripheral device" is used interchangeably with "audio bus device" in this description.

In various aspects, an apparatus may include an audio bus controller coupled to a USB Type-C interface including a plurality of signal pins. The audio bus controller may be configured to transmit and receive signals according to an audio bus protocol on at least one signal pair of the plurality of signal pins to communicate with an audio bus device coupled to the USB Type-C interface. A corresponding apparatus may include an audio bus peripheral circuit configured to transmit and receive signals according to an audio bus protocol on at least one signal pair of a USB Type-C interface to communicate with a host apparatus coupled to the USB Type-C interface. In this way, existing USB Type-C connector pins and board routing may be reused for audio bus communication, without requiring dedicated audio bus pins or connectors. Where the audio bus protocol employs single-ended signaling, a signal converter may be coupled between the audio bus controller and the at least one signal pair, or between the audio bus peripheral circuit and the at least one signal pair, to convert between single-ended signals of the audio bus controller or audio bus peripheral circuit and differential signals on the at least one signal pair.

In various aspects described herein, a power delivery controller may be configured to negotiate a SoundWire Alternate Mode for audio bus communication with an audio bus device via USB PD signaling through the USB Type-C interface and, upon successful negotiation, to configure a multiplexer to route the at least one signal pair to the audio bus controller. A corresponding power delivery controller on the peripheral side may be configured to respond to USB PD signaling from the host apparatus to negotiate the SoundWire Alternate Mode, and upon successful negotiation, to cause the at least one signal pair to be routed to the audio bus peripheral circuit. The peripheral-side power delivery controller may further indicate to the host apparatus one or more of an audio bus protocol type, a signaling rate, or a number of data lanes supported by the audio bus peripheral circuit. Upon successful negotiation, the host-side power delivery controller may further provide an indication to a host processor that the audio bus device is connected to the USB Type-C interface in the alternate mode, to cause the host processor to initiate loading of software for audio bus communication. In this way, audio bus devices connected externally through an exposed USB Type-C port can be discovered automatically and the signal routing of the USB Type-C interface can be dynamically configured without requiring user intervention.

In various aspects described herein, for audio bus devices disposed on the same circuit board as the host apparatus and hard-wired to USB Type-C signal pins, a management controller may be configured to detect audio bus capabilities of the audio bus device by accessing one or more registers of the audio bus device through the USB Type-C interface, and the audio bus controller and the audio bus device may communicate over traces on the common circuit board routed through USB Type-C pin assignments. The audio bus device includes one or more registers accessible by the host apparatus through the USB Type-C interface, the registers storing information indicative of the audio bus capabilities of the audio bus peripheral circuit. In this topology, existing USB physical layer hardware and board routing designed for USB Type-C connectivity can be reused for on-chassis audio bus connections without requiring an external cable or USB PD negotiation over the CC channel.

As used herein, the term "alternate mode" may refer to a mode of USB Type-C operation in which one or more signal pairs of the USB Type-C interface are repurposed to carry non-USB protocol signals, following negotiation between connected devices via USB PD structured Vendor Defined Messages (VDMs) over the CC channel. In the context of this description, the term "SoundWire Alternate Mode" may refer to a specific alternate mode in which signal pairs of the USB Type-C interface are allocated for audio bus communication according to the audio bus protocol, as described herein. The SoundWire Alternate Mode may be applicable to both SoundWire and SWI3S devices.

As used herein, the term "downstream-facing port" (DFP) refers to a USB Type-C port that acts as a host or hub in a USB connection, initiating device discovery and USB PD negotiation. The term "upstream-facing port" (UFP) refers to a USB Type-C port that acts as a device or peripheral in a USB connection, responding to discovery and negotiation initiated by the DFP. In various aspects described herein, the host apparatus may present a DFP and the audio bus device may present a UFP. During USB PD negotiation for the SoundWire Alternate Mode, the DFP may initiate the discovery sequence, as described herein.

As used herein, the term "multiplexer" may refer to a switching circuit coupled between the signal pins of the USB Type-C interface and the audio bus controller or audio bus peripheral circuit. The multiplexer, as described herein, may be configured to selectively route one or more signal pairs to the audio bus controller or audio bus peripheral circuit, or alternatively to a USB controller for standard USB data communication, depending on the mode configured for the USB Type-C interface. The multiplexer routing state may be controlled by firmware based on the negotiated alternate mode or, in on-chassis topologies, based on the result of register-based peripheral discovery, as described herein. In some implementations, the multiplexer may be referred to as a mux or a crossbar switch.

As used herein, the term "signal converter" may refer to a circuit that translates between single-ended signals and differential signals. For example, when the audio bus protocol employs single-ended signaling, such as SoundWire or SWI3S with a single-ended physical layer, and the signal pairs of the USB Type-C interface carry differential signals, a signal converter may be coupled between the audio bus controller or audio bus peripheral circuit and the at least one signal pair to perform this translation at each end of the link. When the audio bus protocol employs differential signaling, such as SWI3S with a differential low-voltage physical layer, the signals are natively compatible with the differential signal pairs of the USB Type-C interface, and a signal converter is not required in the differential signal path.

As used in this description, the term "power delivery controller" (PD controller) refers to a controller that implements the USB PD protocol on the CC pins of the USB Type-C interface, managing power negotiation and alternate mode entry and exit between connected devices. In various aspects described herein, the power delivery controller on the host side may additionally negotiate the SoundWire Alternate Mode with a connected audio bus device and, upon successful negotiation, configure the multiplexer to route the appropriate signal pairs to the audio bus controller. The power delivery controller may further configure the signal converter for parameters established during negotiation, and may provide an indication to a host processor that an audio bus device has been connected in the alternate mode.

As used in this description, the term "management controller" may refer to a firmware-driven controller that detects and manages input/output configurations of devices connected to or disposed on the platform. In various aspects described herein, the management controller may detect audio bus capabilities of an audio bus device by accessing one or more registers of that device through the USB Type-C interface, and communicate the detected capabilities to the audio bus controller and, where applicable, to the host software stack to initiate loading of the appropriate software for audio bus communication. In some implementations, the management controller may be referred to as an I/O Manager (IOM).

As used in this description, the term "USB controller" refers to a controller that manages standard USB data transactions, including USB 2.0 and USB 3.x protocols, on one or more signal pairs of the USB Type-C interface not allocated to the audio bus controller or audio bus peripheral circuit. In aspects where only a subset of the available signal pairs of the USB Type-C interface is allocated for audio bus communication, the remaining signal pairs may be coupled to the USB controller to maintain USB data communication concurrently with audio bus communication through the same USB Type-C interface.

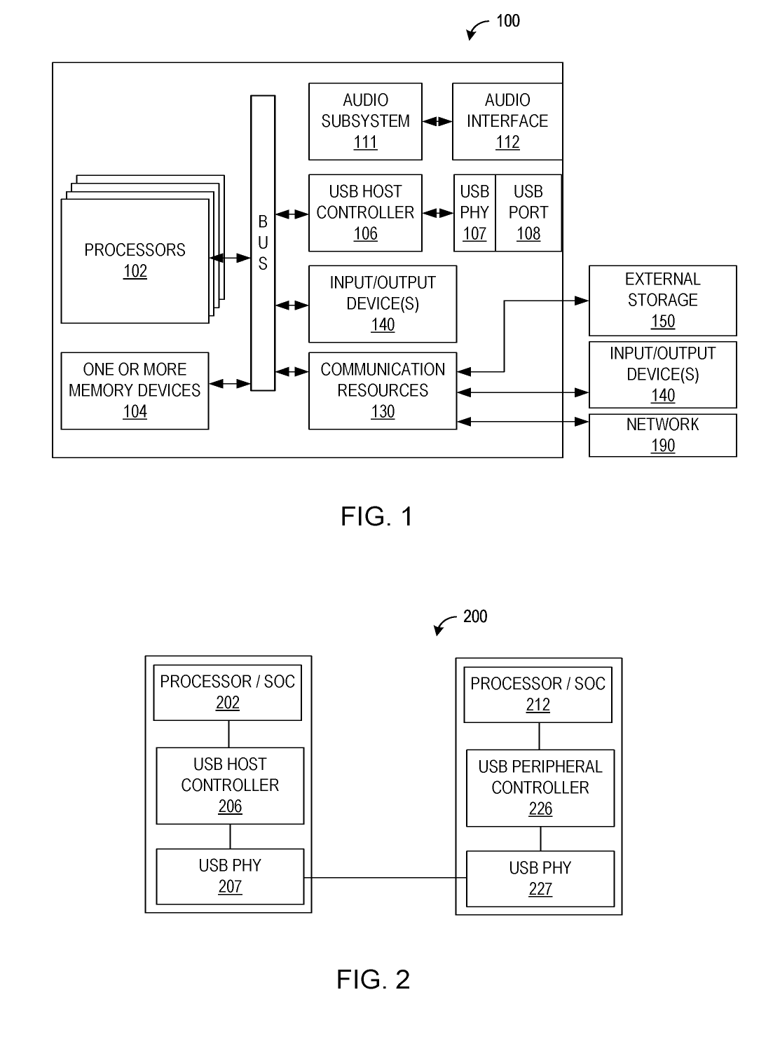

FIG. 1 illustrates a block diagram of an example computing system 100 in accordance with various aspects described herein. The computing system 100 includes a system of interconnected hardware and software resources configured to execute instructions, process data, and manage the allocation of computational capabilities. The computing system 100 may be a personal computer, a laptop computer, a tablet computer, a mobile handset, a server, or any other suitable computing platform in which a USB host controller is present and in which audio peripheral devices may be supported.

The computing system 100 includes one or more processors 102. The one or more processors 102 represent the computational core of the computing system 100. Each processor among the one or more processors 102 executes instructions, processes data, and manages system operations. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. The one or more processors 102 communicate with other components of the computing system 100 via a bus.

The computing system 100 includes one or more memory devices 104 coupled to the one or more processors 102. The one or more memory devices 104 provide the main storage for data and instructions that are actively used by the one or more processors 102 during operation. The one or more memory devices 104 may include volatile memory technologies, such as dynamic random access memory or synchronous dynamic random access memory, or non-volatile memory technologies, such as static random access memory. The one or more memory devices 104 store instructions that are loaded and executed by the one or more processors 102, and store data that is read from and written to by the one or more processors 102 during the execution of those instructions.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory. Each memory device 104 may be packaged individually or in a vertically stacked arrangement within a common package, and may include one or more independently addressable ranks accessible via respective chip select signals.

The one or more processors 102 and the other components of the computing system 100 are coupled to one another via the bus. The bus provides the data pathways over which the one or more processors 102 communicate with each of the other components of the computing system 100, and may include point-to-point interconnects, a shared parallel bus, a serial interconnect fabric, or any suitable combination thereof. In some examples, one or more I/O functions of the computing system 100 may be implemented within a platform controller hub (PCH) or an I/O expansion die (IOE die) coupled to the one or more processors 102 via the bus, the PCH or IOE die providing connectivity to various I/O devices and peripherals of the computing system 100.

The computing system 100 includes a USB host controller 106 and a USB physical-layer transceiver 107 coupled to the one or more processors 102 via the bus. The USB host controller 106 is a hardware component that initiates and manages USB communication on behalf of the computing system 100, including generating USB transactions, controlling the scheduling and sequencing of USB transactions, and performing USB enumeration of connected USB devices. The USB physical-layer transceiver 107 is coupled to the USB host controller 106 and handles the electrical signaling of USB communication, converting digital signals generated by the USB host controller 106 into the differential electrical signals defined by the USB specification for transmission, and converting received differential electrical signals back into digital signals for the USB host controller 106.

The computing system 100 includes a USB port 108 coupled to the USB physical-layer transceiver 107, through which USB devices are physically connected to the computing system 100. The USB port 108 may be implemented as a USB Type-C port including a USB Type-C connector with the plurality of signal pins as described herein, including transmit differential pairs, receive differential pairs, a USB 2.0 data pair, sideband use pins, and configuration channel pins. The computing system 100 may provide one or more such USB Type-C ports, which may be externally exposed for connection to external peripheral devices via a USB Type-C cable, or disposed as internal on-chassis connections to peripheral devices soldered on the same circuit board as the computing system 100.

The computing system 100 may include additional communication interfaces and input/output interfaces. The communication resources 130 may include one or more network interface controllers that connect the computing system 100 to a network 190. The network 190 may be a local area network, a wide area network, or the internet, through which the computing system 100 may exchange data with remote hardware resources and external storage 150. The input/output devices 140 may include display interfaces, storage controllers, human interface device controllers, and hardware accelerators coupled to the bus. The computing system 100 may further include wireless communication components, such as Wi-Fi or cellular communication modules, as part of the communication resources 130.

The computing system 100 includes an audio subsystem 111 coupled to the one or more processors 102 via the bus. The audio subsystem 111 is a hardware and software component that processes audio data for playback and capture within the computing system 100. The audio subsystem 111 includes one or more audio bus controllers configured to manage audio bus protocol communication with audio peripheral devices, including generating clock signals, framing audio data, and controlling one or more audio bus peripheral circuits. The one or more audio bus controllers of the audio subsystem 111 may include, for example, a SoundWire Manager for communication according to the SoundWire protocol, a SWI3S Manager for communication according to the SWI3S protocol, or any combination thereof.

The input/output devices 140 associated with the computing system 100 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 1 also illustrates input/output devices 140 external to the computing system 100, which may represent peripherals connected via the communication resources 130 or the network 190, providing flexibility in system configuration.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The computing system 100 illustrated in FIG. 1 represents an example computing environment in which the embodiments described hereinafter may be implemented. The specific configuration of the computing system 100 shown in FIG. 1 is illustrative and not limiting, and the embodiments described hereinafter may be implemented in any computing system that includes a USB host controller, a USB physical-layer transceiver, and an audio subsystem including one or more audio bus controllers, regardless of the specific processor architecture, memory configuration, or additional interfaces present in the computing system.

FIG. 2 illustrates a system 200 including a host device and a peripheral device coupled via a USB Type-C connection according various aspects described herein. The host device and the peripheral device are shown at a high level of abstraction, each including a processor or system-on-chip, a USB controller, and a USB physical-layer transceiver. FIG. 2 provides the topological context for various apparatus embodiments described herein, and illustrates the two-device arrangement in which audio bus communication over USB Type-C signal pins is implemented. In an example, a computing system (e.g., the computing system 100) includes at least the host device described herein.

The host device includes a processor or system-on-chip (SoC) 202, a USB host controller 206 coupled to the processor or SoC 202, and a USB physical-layer transceiver (USB PHY) 207 coupled to the USB host controller 206. The processor or SoC 202 provides the computational and control functions of the host device, including executing the software stack for audio bus communication. The USB host controller 206 manages USB transactions on behalf of the host device. The USB PHY 207 handles the electrical signaling of the USB Type-C interface on the host side and provides the physical connection point through which the host device communicates with the peripheral device via the USB Type-C connection. The host device may further include an audio bus controller, as described herein, coupled to the USB Type-C interface to communicate audio bus protocol signals over at least one signal pair of the USB Type-C signal pins. The host device may be implemented as a computing system such as that described with respect to FIG. 1, a smartphone, a tablet, or any platform including a processor or SoC, a USB host controller, and an audio bus controller.

The peripheral device includes a processor or system-on-chip 212, a USB peripheral controller 226 coupled to the processor or SoC 212, and a USB physical-layer transceiver 227 coupled to the USB peripheral controller 226. The processor or SoC 212 provides the computational and control functions of the peripheral device. The USB peripheral controller 226 manages USB transactions on the peripheral side of the connection. The USB PHY 227 handles the electrical signaling of the USB Type-C interface on the peripheral side and provides the physical connection point through which the peripheral device communicates with the host device via the USB Type-C connection. The peripheral device may further include an audio bus peripheral circuit, as described herein, coupled to the USB Type-C interface to communicate audio bus protocol signals over at least one signal pair of the USB Type-C signal pins. The peripheral device may be an audio accessory, a wearable audio device, an augmented reality or virtual reality headset, a SWI3S debugger, or any device including an audio bus peripheral circuit such as an audio codec, an audio amplifier, or a microphone array.

The USB Type-C connection between the host device and the peripheral device may take one of two topological forms. In the first topology, the USB Type-C connection may be an external cable connection between exposed USB Type-C ports on the host device and the peripheral device respectively, enabling connection of externally attached audio bus devices. In the second topology, the USB Type-C connection may be a hard-wired on-chassis connection, wherein the host device and the peripheral device can be disposed on a common circuit board and the signal pairs of the USB Type-C interface are routed between them by traces on that common circuit board, without a physical cable. The topology of the USB Type-C connection may affect the discovery and configuration mechanism used to establish audio bus communication, as described herein.

In either topology, at least one signal pair of the USB Type-C interface may be configured to carry audio bus protocol signals between the audio bus controller of the host device and the audio bus peripheral circuit of the peripheral device. One or more further signal pairs of the USB Type-C interface not allocated to the audio bus controller may concurrently carry standard USB data signals managed by a USB controller on the host side and a USB controller on the peripheral side, enabling simultaneous audio bus communication and USB data communication through the same USB Type-C connection.

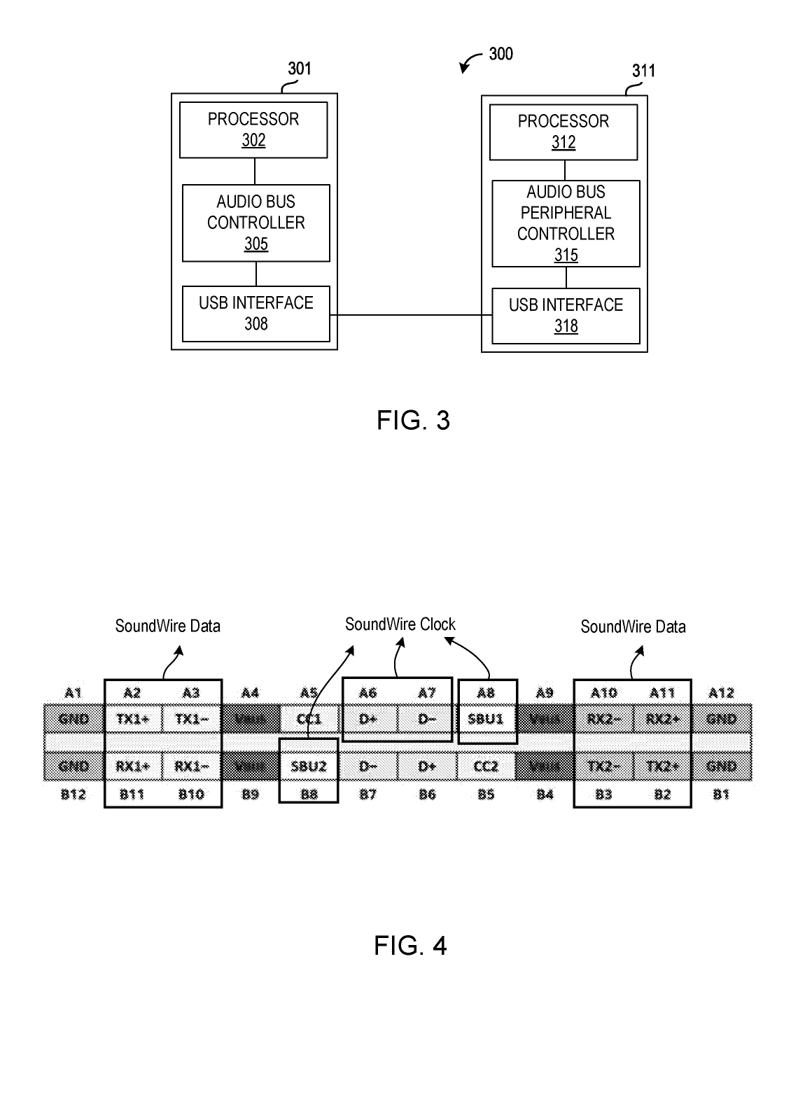

FIG. 3 illustrates schematically a block diagram of a system 300. The system 300 includes a host apparatus 301 and a peripheral apparatus 311. In an example, the host device described in accordance with FIG. 2 includes the host apparatus and the peripheral device described in accordance with FIG. 3 includes the peripheral apparatus 311. The host apparatus 301 includes a processor 302, an audio bus controller 305 coupled to the processor 302, and a USB interface 308 coupled to the audio bus controller 305. The peripheral apparatus 311 includes a processor 312, an audio bus peripheral circuit 315 coupled to the processor 312, and a USB interface 318 coupled to the audio bus peripheral circuit 315. The host apparatus 301 may correspond to host systems described herein. The peripheral apparatus 311 may correspond to PD-capable USB devices described herein.

The USB interface 308 of the host apparatus 301 and the USB interface 318 of the peripheral apparatus 311 may be each implemented as a USB Type-C interface including a plurality of signal pins as described herein, and are coupled to one another via a USB Type-C connection to form a system 300. The USB Type-C connection between the USB interface 308 and the USB interface 318 may be an external cable connection or a hard-wired on-chassis connection, as described herein.

The audio bus controller 305 is coupled to the USB interface 308 and is configured to transmit and receive signals according to an audio bus protocol on at least one signal pair of the plurality of signal pins of the USB interface 308, to communicate with the audio bus peripheral circuit 315 of the peripheral apparatus 311 coupled to the USB interface 308 via the USB Type-C connection. The audio bus peripheral circuit 315, which may also be referred to as an audio bus peripheral controller in some implementations, is coupled to the USB interface 318 and is configured to transmit and receive signals according to an audio bus protocol on at least one signal pair of the plurality of signal pins of the USB interface 318, to communicate with the host apparatus 301 coupled to the USB interface 318 via the USB Type-C connection. In this way, the audio bus controller 305 and the audio bus peripheral circuit 315 together may implement an audio bus protocol link over the USB Type-C connection between the host apparatus 301 and the peripheral apparatus 311, reusing signal pairs of the USB Type-C interface that would otherwise be allocated solely to USB data communication.

In an example, the audio bus controller 305 acts as a bus manager or master in the audio bus protocol, and may be configured to generate clock signals defining the timing of audio bus protocol transactions, frame audio data for transmission according to the audio bus protocol, and/or control the operational state of one or more audio bus peripheral circuits connected on the audio bus. In some examples, the audio bus controller 305 is a SoundWire Manager configured to manage SoundWire protocol transactions, or a SWI3S Manager configured to manage SWI3S protocol transactions, or a controller capable of managing both protocols. The processor 302 interacts with the audio bus controller 305 to configure audio bus parameters, initiate audio data transfers, and process audio data received from the audio bus peripheral circuit 315.

The USB interface 308 of the host apparatus 301 provides the physical medium over which the audio bus controller 305 communicates with the peripheral apparatus 311. The USB interface 308 includes a plurality of signal pins including transmit differential pairs TX1+/TX1− and TX2+/TX2−, receive differential pairs RX1+/RX1− and RX2+/RX2−, a USB 2.0 data pair D+/D−, sideband use pins SBU1 and SBU2, and configuration channel pins CC1 and CC2. The audio bus controller 305 may be coupled to the USB interface 308 such that audio bus protocol signals generated by the audio bus controller 305 are routed onto at least one signal pair of these plurality of signal pins for transmission to the peripheral apparatus 311, and audio bus protocol signals received from the peripheral apparatus 311 on the at least one signal pair are provided to the audio bus controller 305. For example, the USB interface 318 of the peripheral apparatus 311 has a corresponding set of signal pins, and operates symmetrically with the USB interface 308 with respect to the audio bus protocol link.

The at least one signal pair on which the audio bus controller 305 transmits and receives audio bus protocol signals may be selected from one or more of the transmit differential pairs, the receive differential pairs, the USB 2.0 data pair, or the sideband use pins of the USB interface 308. The selection of the at least one signal pair may be based on the specific audio bus protocol variant in use and the number of audio bus signals to be transported. For example, in an embodiment employing the SoundWire protocol with a single data lane, the audio bus controller 305 may use a first signal pair for the SoundWire clock signal and a second signal pair for the SoundWire data signal. In an embodiment employing the SWI3S protocol with a differential low-voltage physical layer, the audio bus controller 305 may use a single differential signal pair for the SWI3S Data+ and Data− signals. The specific pin mappings for each protocol variant are described herein.

The audio bus controller 305 is configured to transmit signals according to the audio bus protocol on the at least one signal pair, and to receive signals according to the audio bus protocol on the at least one signal pair, in a bidirectional audio bus protocol exchange with the audio bus peripheral circuit 315 of the peripheral apparatus 311. The audio bus protocol defines the encoding, framing, and timing of signals exchanged between the audio bus controller 305 and the audio bus peripheral circuit 315, including clock signals, data signals, and control information embedded within the protocol frame. The bidirectional nature of the audio bus protocol link over the USB Type-C signal pairs can enable the audio bus controller 305 to transmit audio data to the audio bus peripheral circuit 315, for example to drive an audio amplifier or speaker, and to receive audio data from the audio bus peripheral circuit 315, for example from a microphone array or audio codec, over the same USB Type-C connection.

In an example, the audio bus peripheral circuit 315 acts as a peripheral or target in the audio bus protocol, responding to clock and control signals generated by the audio bus controller 305 and transmitting and receiving audio data as directed by the audio bus protocol. In some implementations, the audio bus peripheral circuit 315 is a SoundWire peripheral configured to respond to SoundWire protocol transactions, or a SWI3S peripheral configured to respond to SWI3S protocol transactions. The processor 312 of the peripheral apparatus 311 may interact with the audio bus peripheral circuit 315 to configure peripheral-side audio parameters, manage audio data buffers, and process audio data exchanged with the host apparatus 301. The audio bus peripheral circuit 315 may include at least one of an audio codec, an audio amplifier, or a microphone array, each of which is described in further detail herein.

The interoperation of the audio bus controller 305 and the audio bus peripheral circuit 315 over the USB Type-C connection requires that corresponding signal pairs of the USB interface 308 and the USB interface 318 carry the audio bus protocol signals between the two devices. The audio bus controller 305 and the audio bus peripheral circuit 315 may be each configured to use the same signal pairs for audio bus protocol communication, such that clock and data signals transmitted by the audio bus controller 305 on a given signal pair of the USB interface 308 are received by the audio bus peripheral circuit 315 on the corresponding signal pair of the USB interface 318, and vice versa. This correspondence may be established either through USB PD negotiation of the SoundWire Alternate Mode, in the external connection topology, or through register-based capability discovery, in the on-chassis topology, as described herein.

The audio bus protocol employed by the audio bus controller 305 and the audio bus peripheral circuit 315 may be a single-ended protocol or a differential protocol. When the audio bus protocol is a single-ended protocol, such as SoundWire or SWI3S with a single-ended physical layer, the audio bus controller 305 generates single-ended clock and data signals, and the audio bus peripheral circuit 315 receives and transmits single-ended clock and data signals. In this case, conversion between the single-ended signals of the audio bus controller 305 and the differential signals on the signal pairs of the USB interface 308 may be performed by a signal converter, as described herein. When the audio bus protocol is a differential protocol, such as SWI3S with a differential low-voltage physical layer, the audio bus controller 305 generates differential Data+ and Data− signals that are natively compatible with the differential signal pairs of the USB interface 308, and no signal converter is required in the differential signal path.

The host apparatus 301 may further include a signal converter coupled between the audio bus controller 305 and the at least one signal pair of the USB interface 308. The signal converter is configured to convert between single-ended signals of the audio bus controller 305 and differential signals on the at least one signal pair of the USB interface 308. The peripheral apparatus 311 may correspondingly include a signal converter coupled between the audio bus peripheral circuit 315 and the at least one signal pair of the USB interface 318, configured to convert between differential signals on the at least one signal pair and single-ended signals of the audio bus peripheral circuit 315. The signal converter on the host side translates single-ended clock and data signals generated by the audio bus controller 305 into differential signals for transmission on the at least one signal pair of the USB interface 308, and translates differential signals received on the at least one signal pair back into single-ended signals for the audio bus controller 305. The signal converter on the peripheral side performs the corresponding translation in the reverse direction. When the audio bus protocol employs differential signaling natively, these signal converters may be omitted from the signal path or electronically bypassed.

The host apparatus 301 may further include a multiplexer coupled between the plurality of signal pins of the USB interface 308 and the audio bus controller 305. The multiplexer is configurable to selectively route the at least one signal pair to the audio bus controller 305 for audio bus communication, or alternatively to route that signal pair to a USB controller for standard USB data communication, depending on the mode configured for the USB interface 308. The peripheral apparatus 311 may correspondingly include a multiplexer coupled between the plurality of signal pins of the USB interface 318 and the audio bus peripheral circuit 315, configurable to selectively route the at least one signal pair to the audio bus peripheral circuit 315 upon configuration of the audio bus communication mode. The multiplexer and the multiplexer are each configured by firmware in response to either a successful USB PD negotiation of the SoundWire Alternate Mode, in the external connection topology, or the result of register-based capability discovery, in the on-chassis topology.

The host apparatus 301 may further include a power delivery controller coupled to the CC pins of the USB interface 308. The power delivery controller is configured to negotiate a SoundWire Alternate Mode for audio bus communication with the audio bus device via USB PD signaling through the USB interface 308, and upon successful negotiation, to configure the multiplexer to route the at least one signal pair to the audio bus controller 305. The power delivery controller may further be configured to, upon successful negotiation, configure the signal converter for at least one of a clock frequency, a signaling rate, or a data line allocation for the audio bus communication.

The peripheral apparatus 311 may correspondingly include a power delivery controller coupled to the CC pins of the USB interface 318, configured to respond to USB PD signaling from the host apparatus 301 to negotiate the SoundWire Alternate Mode, and upon successful negotiation, to cause the at least one signal pair to be routed to the audio bus peripheral circuit 315 via the multiplexer. The power delivery controller may further be configured to indicate to the host apparatus 301 one or more of an audio bus protocol type, a signaling rate, or a number of data lanes supported by the audio bus peripheral circuit 315, during the USB PD negotiation.

The power delivery controller or the management controller of the host apparatus 301 may further be configured to provide, upon successful negotiation of the SoundWire Alternate Mode, an indication to the processor 302 that the audio bus device is connected to the USB interface 308 in the alternate mode, to cause the processor 302 to initiate loading of software for audio bus communication with the audio bus device. This indication allows the software stack of the host apparatus 301 to dynamically load the drivers and firmware components required to manage audio bus communication over the newly established USB Type-C audio bus link, without requiring manual configuration by a user.

The host apparatus 301 may further include a management controller configured to detect audio bus capabilities of the peripheral apparatus 311 by accessing one or more registers of the peripheral apparatus 311 through the USB interface 308. The peripheral apparatus 311 may correspondingly include one or more registers accessible by the host apparatus 301 through the USB interface 318, the registers storing information indicative of the audio bus capabilities of the audio bus peripheral circuit 315, including for example the audio bus protocol type, supported signaling rates, and number of data lanes. The management controller communicates the detected capabilities to the audio bus controller 305 to configure the audio bus communication path. This register-based capability detection mechanism is employed in the on-chassis topology, where the host apparatus 301 and the peripheral apparatus 311 are disposed on a common circuit board and the at least one signal pair is routed between the audio bus controller 305 and the audio bus peripheral circuit 315 by traces on the common circuit board, without requiring USB PD negotiation over the CC channel.

The host apparatus 301 may further include a USB controller coupled to one or more further signal pairs of the plurality of signal pins of the USB interface 308 not allocated to the audio bus controller 305. The USB controller is configured to maintain USB data communication through the USB interface 308 concurrently with audio bus communication by the audio bus controller 305.

The peripheral apparatus 311 may correspondingly include a USB controller coupled to one or more further signal pairs of the plurality of signal pins of the USB interface 318 not allocated to the audio bus peripheral circuit 315, configured to maintain USB data communication concurrently with audio bus communication. In this way, a single USB Type-C connection between the host apparatus 301 and the peripheral apparatus 311 can support simultaneous audio bus protocol traffic and USB data traffic, with different signal pairs of the USB Type-C interface allocated to each function. The host apparatus 301 may further include a further audio bus controller configured to communicate according to a further audio bus protocol on a further signal pair of the USB interface 308, independently of the audio bus controller 305, to support multiple simultaneous audio bus links over the same USB Type-C connection.

FIG. 4 illustrates an example of pin mapping options for SoundWire single-ended clock and data signals on a USB Type-C connector. The USB Type-C connector includes a top row of pins designated A1 through A12 and a bottom row of pins designated B1 through B12. The top row includes, from left to right: ground (A1), transmit differential pair TX1+ (A2) and TX1− (A3), VBUS (A4), configuration channel pin CC1 (A5), USB 2.0 data pins D+ (A6) and D− (A7), sideband use pin SBU1 (A8), VBUS (A9), receive differential pair RX2− (A10) and RX2+ (A11), and ground (A12). The bottom row includes, from right to left: ground (B1), transmit differential pair TX2+ (B2) and TX2− (B3), VBUS (B4), configuration channel pin CC2 (B5), USB 2.0 data pins D+ (B6) and D− (B7), sideband use pin SBU2 (B8), VBUS (B9), receive differential pair RX1− (B10) and RX1+ (B11), and ground (B12). The SoundWire protocol requires one clock signal and one or more data signals, each single-ended, for audio bus communication between the audio bus controller and the audio bus peripheral circuit.

As illustrated in FIG. 4, the SoundWire clock signal may be mapped to the USB 2.0 data pair including pins D+ (A6) and D− (A7), or alternatively to the sideband use pin SBU1 (A8) on the top row or sideband use pin SBU2 (B8) on the bottom row. The SoundWire data signals, which may include a single data lane or multiple data lanes, may each be mapped to a respective signal pair selected from the transmit differential pairs TX1+/TX1− (A2/A3) and TX2+/TX2− (B2/B3), the receive differential pairs RX1+/RX1− (B11/B10) and RX2−/RX2+ (A10/A11), or other available signal pairs of the USB Type-C connector not allocated to the SoundWire clock. In the mapping illustrated in FIG. 4, the SoundWire clock occupies the D+/D− pair and SBU1, while SoundWire data signals occupy the TX1+/TX1−, RX2−/RX2+, RX1+/RX1−, and TX2+/TX2− pairs. Each single-ended SoundWire signal occupies one conductor of a respective differential signal pair of the USB Type-C connector. The mapping illustrated in FIG. 4 is exemplary; other mappings of SoundWire clock and data signals to the available signal pairs of the USB Type-C connector are within the scope of the embodiments described herein.

Because SoundWire signals are single-ended and the signal pairs of the USB Type-C connector carry differential signals, a signal converter may be coupled between the audio bus controller and the at least one signal pair at the host side, and a corresponding signal converter may be coupled between the audio bus peripheral circuit and the at least one signal pair at the peripheral side. Each signal converter translates between single-ended SoundWire clock and data signals and the differential signals carried on the respective signal pairs of the USB Type-C connector, as described herein.

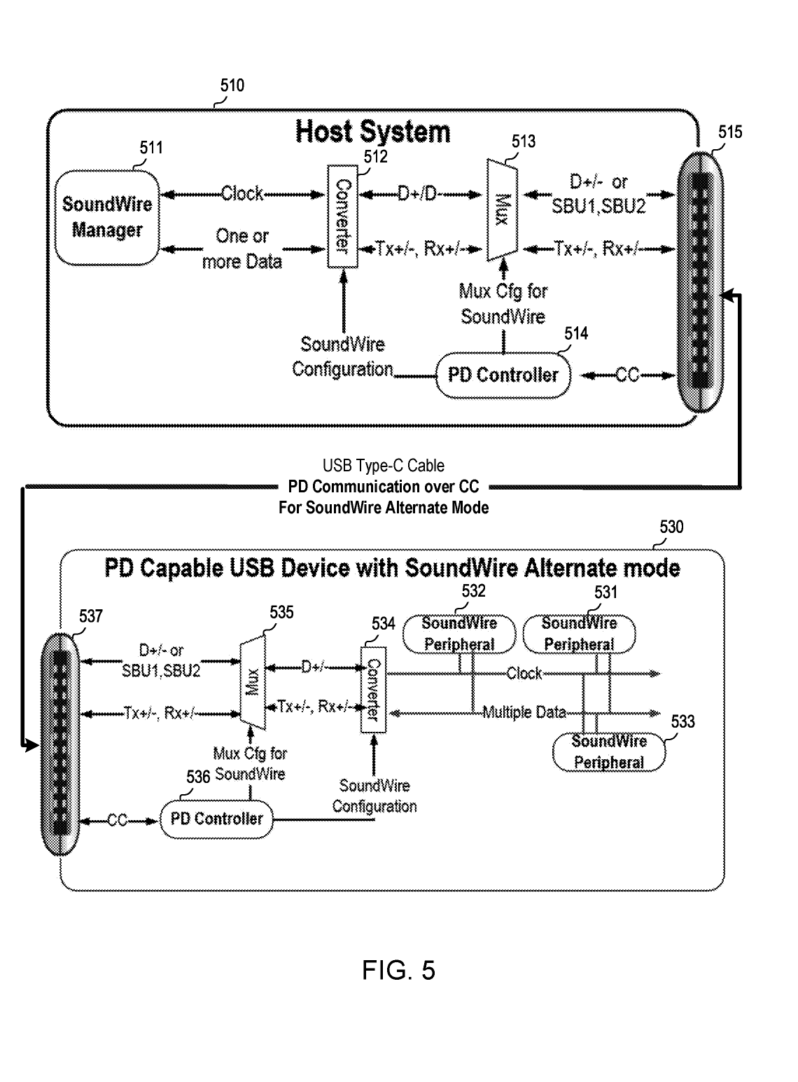

FIG. 5 illustrates an external connection for SoundWire single-ended communication between a host system 510 and a PD-capable USB device 530 supporting the SoundWire Alternate Mode, over a USB Type-C cable. The host system 510 and the PD-capable USB device 530 are each shown with their respective USB Type-C connectors, and are connected by a USB Type-C cable over which PD communication occurs on the CC line for negotiation of the SoundWire Alternate Mode, as described herein.

Referring to the host system 510 in FIG. 5, the audio bus controller, implemented in this example as a SoundWire Manager 511, may generate a single-ended clock signal and one or more single-ended data signals for SoundWire protocol communication. The signal converter 512, coupled between the SoundWire Manager 511 and the multiplexer 513, receives the single-ended clock and data signals from the SoundWire Manager 511 and translates them into differential signals. The multiplexer 513 is coupled between the signal converter 512 and the signal pins of the USB Type-C connector 515, and routes the differential clock signal to the D+/D− or SBU1/SBU2 signal pair and the differential data signals to the Tx+/−, Rx+/− signal pairs, in accordance with the pin mapping described with respect to FIG. 4. The power delivery controller 514 may be coupled to the CC pins of the USB Type-C connector 515 and may configure the multiplexer 513 for SoundWire mode upon successful USB PD negotiation of the SoundWire Alternate Mode. The power delivery controller 514 may further configure the signal converter 512 for the clock frequency, signaling rate, and data line allocation established during negotiation. PD communication between the host system 510 and the PD-capable USB device 530 occurs over the CC line of the USB Type-C cable.

Referring to the PD-capable USB device 530, the power delivery controller 536 may be coupled to the CC pins of the USB Type-C connector of the peripheral device and may negotiate the SoundWire Alternate Mode with the host system 510 in response to USB PD signaling from the power delivery controller 514. Upon successful negotiation, the power delivery controller 536 may configure the multiplexer 535 to route the at least one signal pair carrying SoundWire signals to the signal converter 534. The multiplexer 535 routes the differential signals received on the D+/D−, SBU1/SBU2, and Tx+/−, Rx+/− signal pairs to the signal converter 534, which translates the received differential signals back into single-ended clock and data signals. The single-ended clock and multiple data signals output by the signal converter 534 may be provided to one or more SoundWire peripherals 531, 532, 533, each of which is an audio bus peripheral circuit configured to receive the SoundWire clock and transmit and receive SoundWire data according to the SoundWire protocol. As illustrated, the SoundWire peripherals 531, 532, 533 may be connected on a shared SoundWire bus, receiving the clock signal and communicating on respective data lanes as directed by the SoundWire Manager 511 of the host system 510.

In this example, the audio bus protocol is a single-ended protocol, and the audio bus controller is configured to transmit a clock signal and at least one data signal on respective signal pairs of the plurality of signal pins of the USB Type-C interface. The audio bus peripheral circuit is correspondingly configured to transmit and receive a clock signal and at least one data signal on respective signal pairs of the plurality of signal pins of the USB Type-C interface. The number of data lanes may vary from one to seven for the SoundWire protocol, and different data lanes may be mapped to different signal pairs of the USB Type-C connector in accordance with the mapping options described with respect to FIG. 4. The at least one signal pair used for SoundWire communication includes one or more of a transmit differential pair, a receive differential pair, a USB 2.0 data pair, or a sideband use pair of the USB Type-C interface, on both the host side and the peripheral side. Aspects described in this embodiment may further be expanded to support multiple independent SoundWire buses over a single USB Type-C connector, by mapping the clock and data signals of each additional SoundWire bus to a different set of signal pairs of the USB Type-C connector, such that a single USB Type-C connector supports more than one SoundWire bus simultaneously.

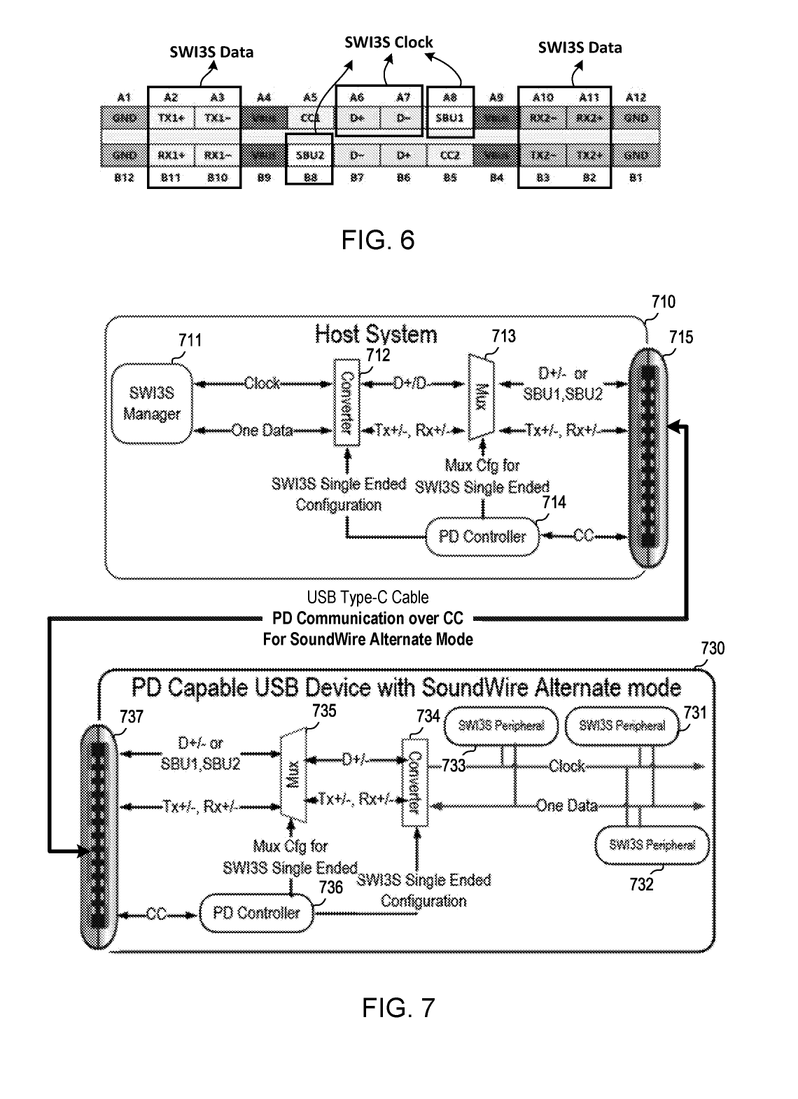

FIG. 6 illustrates example pin mapping options for SWI3S single-ended clock and data signals on a USB Type-C connector. The USB Type-C connector includes a top row of pins designated A1 through A12 and a bottom row of pins designated B1 through B12, with the same pin layout as described with respect to FIG. 4. The SWI3S protocol with a single-ended physical layer requires exactly two signals for audio bus communication: one clock signal and one data signal, each single-ended. This two-signal requirement distinguishes the SWI3S single-ended physical layer from the SoundWire protocol, which may employ one clock signal and between one and seven data signals on respective signal pairs.

As illustrated in FIG. 6, the SWI3S single-ended clock signal may be mapped to the USB 2.0 data pair including pins D+ (A6) and D− (A7) on the top row, or alternatively to the sideband use pin SBU1 (A8) on the top row or sideband use pin SBU2 (B8) on the bottom row. The SWI3S single-ended data signal may be mapped to a signal pair selected from the transmit differential pairs TX1+/TX1− (A2/A3) and TX2+/TX2− (B2/B3), or the receive differential pairs RX1+/RX1− (B11/B10) and RX2−/RX2+ (A10/A11), or other available signal pairs of the USB Type-C connector not allocated to the SWI3S clock. In this mapping, the SWI3S clock occupies the D+/D− pair and SBU1 on the top row, while the SWI3S data signal occupies the TX1+/TX1− pair on the top row left and the RX2−/RX2+ pair on the top row right, with corresponding mappings on the bottom row. Each single-ended SWI3S signal occupies a respective signal pair of the USB Type-C connector. The mapping illustrated in FIG. 6 is exemplary; other mappings of the SWI3S clock and data signals to available signal pairs of the USB Type-C connector are within the scope of the embodiments described herein.

Because the SWI3S single-ended physical layer employs single-ended signaling, and the signal pairs of the USB Type-C connector carry differential signals, a signal converter is coupled between the audio bus controller and the at least one signal pair at the host side, and a corresponding signal converter is coupled between the audio bus peripheral circuit and the at least one signal pair at the peripheral side. Each signal converter translates between the single-ended SWI3S clock and data signals and the differential signals carried on the respective signal pairs of the USB Type-C connector, in the same manner as described herein with respect to the SoundWire single-ended embodiment. The signal conversion requirement applies to the SWI3S single-ended physical layer regardless of the specific signal pairs selected for the SWI3S clock and data mapping.

FIG. 7 illustrates an example of an external connection for SWI3S single-ended communication between a host system 710 and a PD-capable USB device 730 supporting the SoundWire Alternate Mode, over a USB Type-C cable. The host system 710 and the PD-capable USB device 730 are each shown with their respective USB Type-C connectors 715 and 737, and are connected by a USB Type-C cable over which PD communication occurs on the CC line for negotiation of the SoundWire Alternate Mode. The overall architecture of FIG. 7 is analogous to that of FIG. 5, with the SWI3S Manager replacing the SoundWire Manager as the audio bus controller, and one data signal replacing the potentially multiple data signals of the SoundWire single-ended embodiment.

Referring to the host system 710 in FIG. 7, the audio bus controller, implemented in this embodiment as a SWI3S Manager 711, generates a single-ended clock signal and one single-ended data signal for SWI3S protocol communication. The signal converter 712, coupled between the SWI3S Manager 711 and the multiplexer 713, receives the single-ended clock and data signals from the SWI3S Manager 711 and translates them into differential signals. The multiplexer 713 is coupled between the signal converter 712 and the USB Type-C connector 715, and routes the differential clock signal to the D+/D− or SBU1/SBU2 signal pair and the differential data signal to a Tx+/−, Rx+/− signal pair, in accordance with the pin mapping described with respect to FIG. 6. The power delivery controller 714 is coupled to the CC pins of the USB Type-C connector 715 and has configured the multiplexer 713 for SWI3S single-ended mode upon successful USB PD negotiation of the SoundWire Alternate Mode.

During the Discover Modes phase of that negotiation, the peripheral-side power delivery controller 736 may indicate to the power delivery controller 714 that the connected device is a SWI3S device supporting a single-ended physical layer, as described herein. Referring to the PD-capable USB device 730, the power delivery controller 736 may be coupled to the CC pins of the USB Type-C connector 737 and may negotiate the SoundWire Alternate Mode with the host system 710. Upon successful negotiation, the power delivery controller 736 may configure the multiplexer 735 to route the signal pairs carrying SWI3S signals to the signal converter 733. The signal converter 733 translates the received differential signals back into single-ended clock and data signals, which are provided to one or more SWI3S peripherals 731, 732, each of which is an audio bus peripheral circuit configured to receive the SWI3S clock and communicate on the SWI3S data signal according to the SWI3S single-ended protocol. The SWI3S peripherals 731, 732 are connected in a SWI3S single-ended configuration, receiving the clock signal and communicating on the data signal as directed by the SWI3S Manager 711 of the host system 710.

The embodiment described in accordance with FIG. 7 may further be expanded to support multiple independent SWI3S single-ended buses over a single USB Type-C connector, by mapping the clock and data signals of each additional SWI3S single-ended bus to a different set of signal pairs of the USB Type-C connector. In such an expansion, a further audio bus controller on the host side may communicate with a further audio bus peripheral circuit on the peripheral side on a further signal pair independently of the first SWI3S single-ended bus, such that a single USB Type-C connector supports more than one SWI3S single-ended bus simultaneously.

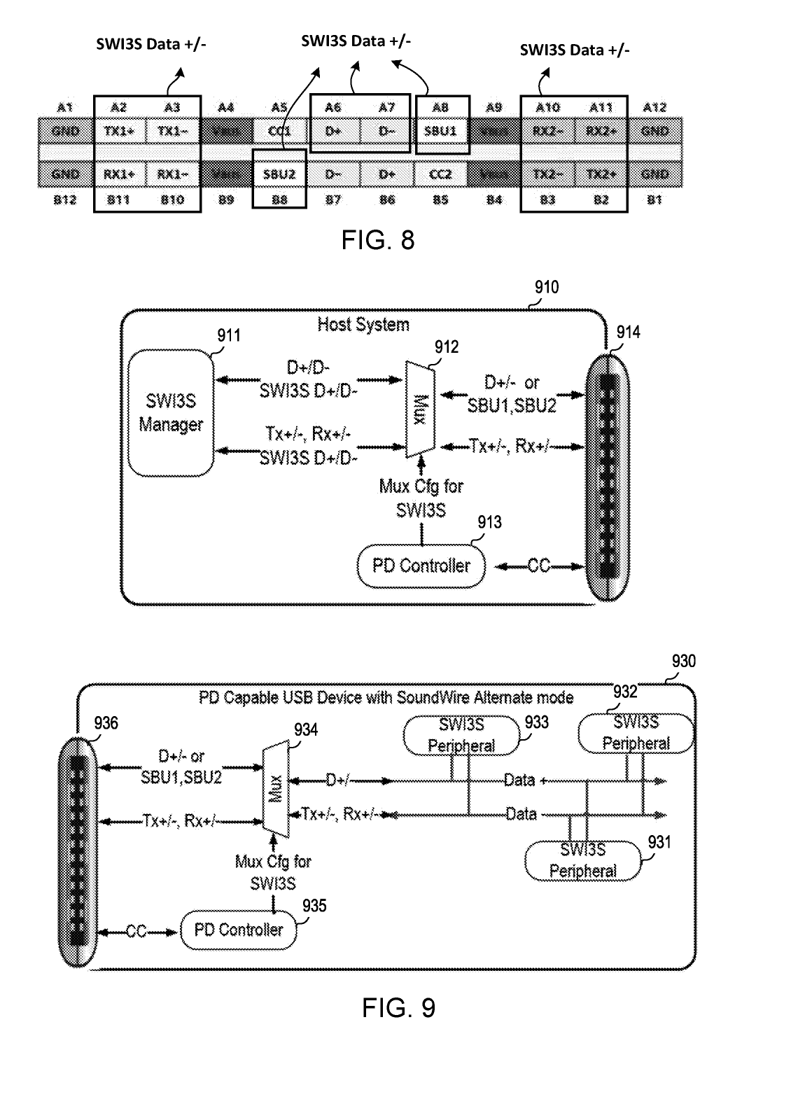

FIG. 8 illustrates example pin mapping options for SWI3S differential low-voltage Data+ and Data− signals on a USB Type-C connector. The USB Type-C connector includes the same top row of pins A1 through A12 and bottom row of pins B1 through B12 as described with respect to FIGS. 4 and 6. The SWI3S differential low-voltage physical layer may transmit audio bus data as a single differential signal pair including a Data+ conductor and a Data− conductor, rather than separate single-ended clock and data signals as employed by the SoundWire and SWI3S single-ended physical layers described with respect to FIGS. 4 through 7. The SWI3S differential low-voltage physical layer can support data rates up to approximately 76 Mbps, which may correspond to the maximum data rate of the SWI3S protocol.

As illustrated in FIG. 8, the SWI3S differential low-voltage Data+/Data− signal pair may be mapped to any differential signal pair of the USB Type-C connector. The mapping options include the transmit differential pairs TX1+/TX1− (A2/A3) and TX2+/TX2− (B2/B3), the receive differential pairs RX1+/RX1− (B11/B10) and RX2−/RX2+ (A10/A11), the USB 2.0 data pair D+/D− (A6/A7 and B6/B7), and the sideband use pins SBU1 (A8) and SBU2 (B8). In the mapping illustrated in FIG. 8, SWI3S Data+/Data− is shown mapped to the TX1+/TX1− pair on the top row left, the D+/D− and SBU1 positions in the center of the top row, and the RX2−/RX2+ pair on the top row right, with corresponding positions on the bottom row, indicating that multiple signal pairs are available for the SWI3S differential data mapping. Multiple SWI3S differential low-voltage buses may be supported simultaneously by mapping each additional SWI3S Data+/Data− pair to a different differential signal pair of the USB Type-C connector. The mapping illustrated in FIG. 8 is exemplary; other mappings of SWI3S differential low-voltage Data+/Data− to the available differential signal pairs of the USB Type-C connector are within the scope of the embodiments described herein.

Because the SWI3S differential low-voltage signals are natively differential and the signal pairs of the USB Type-C connector are also differential, the SWI3S Data+/Data− signals are electrically compatible with the differential signal pairs of the USB Type-C connector without requiring active signal conversion. Accordingly, a signal converter is not required in the differential signal path for the SWI3S differential low-voltage physical layer embodiment. The SWI3S Data+/Data− signals may be routed directly from the audio bus controller through the multiplexer to the selected signal pair of the USB Type-C connector on the host side, and directly from the selected signal pair of the USB Type-C connector through the multiplexer to the audio bus peripheral circuit on the peripheral side, without interposition of a signal converter.

FIG. 9 illustrates an example external connection for SWI3S differential low-voltage communication between a host system 910 and a PD-capable USB device 930 supporting the SoundWire Alternate Mode, over a USB Type-C cable. The host system 910 and the PD-capable USB device 930 are each shown with their respective USB Type-C connectors 914 and 936, and are connected by a USB Type-C cable over which PD communication occurs on the CC line for negotiation of the SoundWire Alternate Mode. The overall architecture of FIG. 9 is analogous to that of FIGS. 5 and 7 with respect to the PD negotiation and multiplexer configuration, but differs in that no signal converter blocks are present in the signal path on either the host side or the peripheral side, reflecting the native differential compatibility of the SWI3S differential low-voltage physical layer with the USB Type-C differential signal pairs.

Referring to the host system 910, the audio bus controller, implemented in this embodiment as a SWI3S Manager 911, generates differential SWI3S Data+/Data− signals natively. The multiplexer 912 is coupled between the SWI3S Manager 911 and the USB Type-C connector 914, and receives the differential SWI3S Data+/Data− signals directly from the SWI3S Manager 911 without interposition of a signal converter. The multiplexer 912 routes the SWI3S Data+/Data− signals to the selected signal pair of the USB Type-C connector 914, which may be the D+/D− or SBU1/SBU2 pair, or the Tx+/−, Rx+/− pairs, in accordance with the pin mapping described with respect to FIG. 8. The power delivery controller 913 is coupled to the CC pins of the USB Type-C connector 914 and may configure the multiplexer 912 for SWI3S differential low-voltage mode upon successful USB PD negotiation of the SoundWire Alternate Mode. During the Discover Modes phase of that negotiation, the peripheral-side power delivery controller may indicate to the power delivery controller 913 that the connected device is a SWI3S device supporting a differential low-voltage physical layer, enabling the power delivery controller 913 to select the appropriate mux configuration and to omit signal converter configuration from the mode entry sequence.

Referring to the PD-capable USB device 930, the power delivery controller 935 is coupled to the CC pins of the USB Type-C connector 936 and may negotiate the SoundWire Alternate Mode with the host system 910. Upon successful negotiation, the power delivery controller 935 may configure the multiplexer 934 to route the selected signal pair of the USB Type-C connector 936 directly to the audio bus peripheral circuit. The multiplexer 934 routes the differential SWI3S Data+/Data− signals received on the D+/D− or Tx+/−, Rx+/− signal pairs directly to one or more SWI3S peripherals 931, 932, 933, each of which is an audio bus peripheral circuit configured to receive and transmit differential SWI3S data according to the SWI3S differential low-voltage protocol. No signal converter is interposed between the multiplexer 934 and the SWI3S peripherals 931, 932, 933 on the peripheral side. The SWI3S peripherals 931, 932, 933 are connected in a SWI3S differential low-voltage configuration, communicating on the Data+/Data− differential pair as directed by the SWI3S Manager 911 of the host system 910.

In this embodiment, the audio bus protocol is a differential protocol, and the audio bus controller is configured to transmit and receive differential data signals on the at least one signal pair of the plurality of signal pins of the USB Type-C interface. The audio bus peripheral circuit is correspondingly configured to transmit and receive differential data signals on the at least one signal pair of the plurality of signal pins of the USB Type-C interface. The at least one signal pair used for SWI3S differential low-voltage communication includes one or more of a transmit differential pair, a receive differential pair, a USB 2.0 data pair, or a sideband use pair of the USB Type-C interface, on both the host side and the peripheral side. This embodiment may further be expanded to support multiple independent SWI3S differential low-voltage buses over a single USB Type-C connector, by mapping each additional SWI3S Data+/Data− pair to a different differential signal pair of the USB Type-C connector, such that a single USB Type-C connector supports more than one SWI3S differential low-voltage bus simultaneously, each communicating with a respective further audio bus peripheral circuit independently of the others.

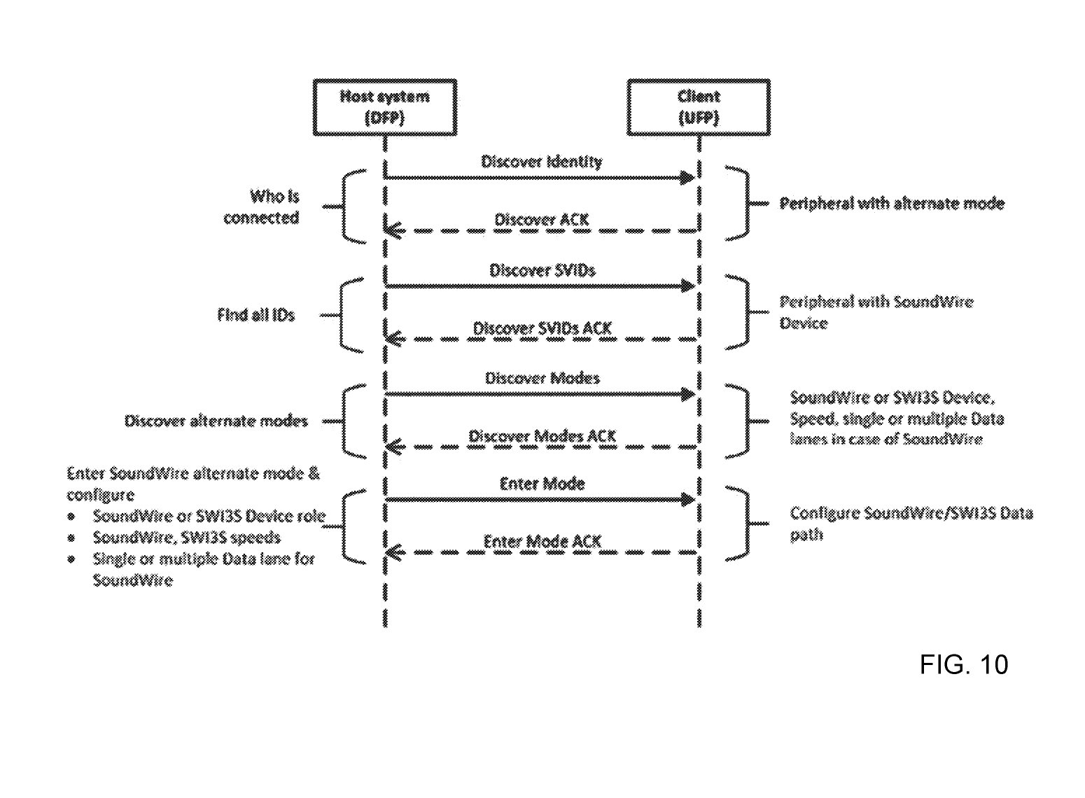

FIG. 10 illustrates an example message sequence for USB PD negotiation of the SoundWire Alternate Mode between a host system including as a downstream-facing port (DFP) and a client peripheral including an upstream-facing port (UFP), connected via a USB Type-C cable. The message sequence can proceed in chronological order from top to bottom and may include four phases: A phase of Discover Identity, a phase of Discover SVIDs, a phase of Discover Modes, and a phase of Enter Mode. In an example, the Discover SVIDs ACK may carry a SoundWire Standard or Vendor ID. In an example, the Discover Modes ACK may carry SoundWire or SWI3S capability information. In an example, the Enter Mode command and acknowledgement may be used to establish the SoundWire Alternate Mode and configure the audio bus data path on both sides of the connection.

The first phase of the negotiation sequence may include the Discover Identity phase, in which the host system transmits a Discover Identity command to the client peripheral over the CC line of the USB Type-C connection. The Discover Identity command may initiate device discovery and request that the peripheral identify itself and its general capabilities. The client peripheral may respond with a Discover ACK, indicating that it is a peripheral with alternate mode capability. The exchange of the Discover Identity command and the Discover ACK establishes that an alternate-mode-capable device is connected to the host system, and enables the host system to proceed to the next phase of negotiation. The power delivery controller of the host apparatus may transmit the Discover Identity command, and the power delivery controller of the peripheral apparatus may generate the Discover ACK in response.

The second phase of the negotiation sequence may include the Discover SVIDs phase, in which the host system transmits a Discover SVIDs command to the client peripheral to enumerate all Standard or Vendor IDs supported by the peripheral. The client peripheral may respond with a Discover SVIDs ACK that includes a SoundWire Standard or Vendor ID in its payload, indicating that the peripheral includes an audio bus peripheral circuit capable of operating in the SoundWire Alternate Mode. The host system's power delivery controller may inspect the Discover SVIDs ACK payload and may identify the SoundWire Standard or Vendor ID, confirming that the connected peripheral supports a SoundWire or SWI3S audio bus protocol. The Discover SVIDs ACK thus can constitute the peripheral apparatus indicating to the host apparatus that it supports an audio bus protocol type, within the USB PD negotiation framework.

The third phase of the negotiation sequence may include the Discover Modes phase, in which the host system transmits a Discover Modes command to the client peripheral for the SoundWire Standard or Vendor ID identified in the preceding phase. The client peripheral responds with a Discover Modes ACK whose payload may communicate the specific audio bus capabilities of the peripheral's audio bus peripheral circuit. As illustrated in FIG. 10, the Discover Modes ACK payload may identify whether the peripheral is a SoundWire device or a SWI3S device, specify the supported signaling speed or speeds, and, in the case of a SoundWire device, indicate whether single or multiple data lanes are supported. The power delivery controller of the peripheral apparatus may be configured to generate this Discover Modes ACK payload, thereby indicating to the host apparatus one or more of an audio bus protocol type, a signaling rate, and a number of data lanes supported by the audio bus peripheral circuit. The host system's power delivery controller receives and evaluates the Discover Modes ACK payload to determine compatibility with the host apparatus and to select the configuration parameters for mode entry.

The fourth phase of the negotiation sequence may include the Enter Mode phase, in which the host system transmits an Enter Mode command to the client peripheral to activate the SoundWire Alternate Mode. As illustrated in FIG. 10, the Enter Mode command transmitted by the host system may configure at least one or a combination of the following parameters: the SoundWire or SWI3S device role of the peripheral, the SoundWire or SWI3S speeds to be used for the audio bus communication link, and, for SoundWire devices, the single or multiple data lane allocation for the connection. The client peripheral may receive the Enter Mode command, configure its SoundWire or SWI3S data path accordingly, and return an Enter Mode ACK to the host system. Receipt of the Enter Mode ACK by the host system's power delivery controller can mark the successful completion of the SoundWire Alternate Mode negotiation.

Upon receipt of the Enter Mode ACK, the power delivery controller of the host apparatus may configure the multiplexer to route the at least one signal pair, selected in accordance with the negotiated protocol type and data lane allocation, to the audio bus controller. Where the negotiated audio bus protocol employs a single-ended physical layer, the power delivery controller may further configure the signal converter for the clock frequency, signaling rate, and data line allocation established during the Enter Mode phase. Where the negotiated audio bus protocol employs a differential low-voltage physical layer, no signal converter configuration is required and the multiplexer routes the selected differential signal pair directly to the audio bus controller. The power delivery controller of the host apparatus may additionally provide an indication to the host processor that an audio bus device is connected to the USB Type-C interface in the SoundWire Alternate Mode, to cause the host processor to initiate loading of the software required for audio bus communication with the audio bus device.

Upon receipt of the Enter Mode command, the power delivery controller of the peripheral apparatus may cause the at least one signal pair to be routed to the audio bus peripheral circuit via the multiplexer on the peripheral side. Where the negotiated audio bus protocol employs a single-ended physical layer, the signal converter on the peripheral side may be configured to translate differential signals received on the at least one signal pair into single-ended clock and data signals for the audio bus peripheral circuit, and to translate single-ended signals from the audio bus peripheral circuit into differential signals for transmission on the at least one signal pair. Where the negotiated audio bus protocol employs a differential low-voltage physical layer, the multiplexer may route the selected differential signal pair directly to the audio bus peripheral circuit without interposition of a signal converter. Following configuration, the audio bus peripheral circuit may enter an active audio bus communication state and may be ready to exchange audio bus protocol signals with the audio bus controller of the host apparatus over the allocated USB Type-C signal pairs.

Following successful completion of the SoundWire Alternate Mode negotiation, audio bus communication can proceed natively over the allocated signal pairs of the USB Type-C interface, with the audio bus controller of the host apparatus and the audio bus peripheral circuit of the peripheral apparatus exchanging clock, data, and control signals according to the negotiated audio bus protocol. The CC channel of the USB Type-C interface remains available for ongoing USB PD communication, including power negotiation and mode exit signaling, concurrently with audio bus communication on the allocated signal pairs. The SoundWire Alternate Mode negotiation sequence described with respect to FIG. 10 is applicable to both SoundWire and SWI3S devices; the specific audio bus protocol type is identified during the Discover Modes phase, and the Enter Mode command parameters are set accordingly for each protocol variant.

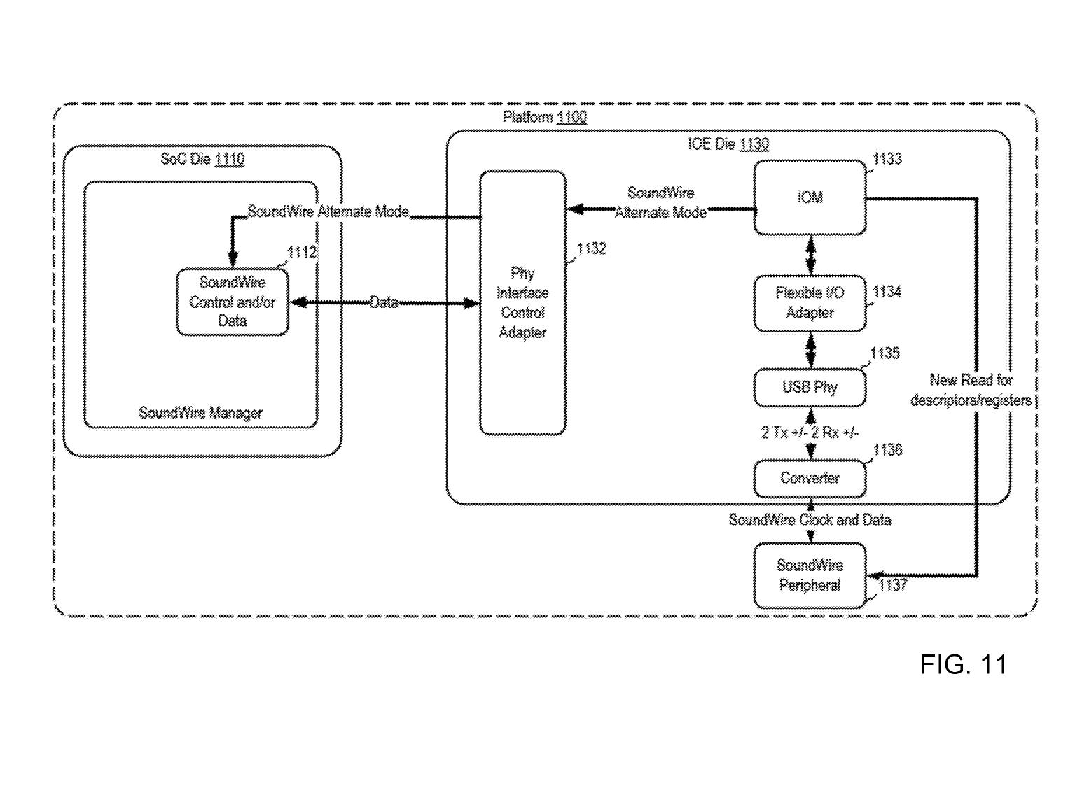

FIG. 11 illustrates an example on-chassis hard-wired connection for SoundWire single-ended communication within a platform 1100, wherein the audio bus peripheral circuit is disposed on the same platform board as the host apparatus and is hard-wired to USB Type-C signal pins by traces on the common circuit board. The platform 1100 includes two dies: a system-on-chip die (SoC Die) 1110 including the audio bus controller and associated SoundWire Alternate Mode logic, and an I/O expansion die (IOE Die) 1130 including the management controller, the flexible I/O adapter, the USB physical-layer transceiver, and the signal converter. In an example, the SoC Die 1110 may correspond to the host apparatus 310 as described herein and the IOE die 1130 may correspond to the peripheral apparatus 330 as described herein. A SoundWire peripheral 1137, acting as the audio bus peripheral circuit in this embodiment, may be disposed on the platform board outside the IOE Die 1130 and is connected to the IOE Die 1130 by board traces carrying SoundWire clock and data signals routed through USB Type-C pin assignments. No external USB Type-C cable may be present in this topology; the USB Type-C signal pairs can be implemented as board-level traces within the platform 1100.

The SoC Die 1110 includes the audio bus controller, implemented in this embodiment as a SoundWire Manager, together with a SoundWire Control and/or Data block (circuitry) 1112 and SoundWire Alternate Mode logic. The SoundWire Manager generates control and audio data signals for transmission to the SoundWire peripheral 1137 and receives audio data from the SoundWire peripheral 1137. The SoundWire Control and/or Data block 1112 is coupled to a Phy Interface Control Adapter 1132 disposed within the IOE Die 1130, and communicates SoundWire control and data signals to the Phy Interface Control Adapter 1132 via a data path between the SoC Die 1110 and the IOE Die 1130. The SoundWire Alternate Mode logic within the SoC Die 1110 coordinates with the SoundWire Alternate Mode logic within the IOE Die 1130 to establish and maintain the SoundWire Alternate Mode configuration for the on-chassis connection.

The IOE Die 1130 includes an I/O Manager (IOM) 1133, a Flexible I/O Adapter 1134, a USB physical-layer transceiver (USB Phy) 1135, and a signal converter 1136. The Phy Interface Control Adapter 1132 is coupled between the SoC Die 1110 and the Flexible I/O Adapter 1134, routing SoundWire control and data signals from the SoundWire Manager of the SoC Die 1110 through the IOE Die 1130 to the USB Phy 1135. The Flexible I/O Adapter 1134 is coupled between the Phy Interface Control Adapter 1132 and the USB Phy 1135, and provides the configurable signal routing within the IOE Die 1130 that allocates USB Phy pin assignments to SoundWire audio bus communication. The USB Phy 1135 provides the physical-layer transmit and receive differential pairs, designated 2 Tx+/− and 2 Rx+/−, through which the SoundWire signals are carried on the board traces to the signal converter 1136. The signal converter 1136 may be coupled between the USB Phy 1135 and the SoundWire peripheral 1137, and may translate the differential signals carried on the 2 Tx+/− and 2 Rx+/− board traces into single-ended SoundWire clock and data signals suitable for the SoundWire peripheral 1137, and translates single-ended signals from the SoundWire peripheral 1137 back into differential signals for the USB Phy 1135. The SoundWire peripheral 1137 may receive the single-ended SoundWire clock and data signals from the signal converter 1136 and communicate audio data to and from the SoundWire Manager of the SoC Die 1110 via this signal path.

The IOM 1133 may act as the management controller and may be configured to detect the audio bus capabilities of the SoundWire peripheral 1137 by performing a new register read for descriptors or registers of the SoundWire peripheral 1137 through a USB-specific request and response mechanism over the USB Type-C pin interface. The registers of the SoundWire peripheral 1137 may store information indicative of the audio bus capabilities of the audio bus peripheral circuit, which may further include the audio bus protocol type, supported signaling configurations, and the number of data lanes. The IOM 1133 reads these registers and communicates the detected capabilities to the SoundWire Manager of the SoC Die 1110 via the SoundWire Alternate Mode logic, enabling the SoundWire Manager to configure the audio bus communication path for the on-chassis connection. This register-based discovery mechanism may replace the USB PD negotiation sequence described with respect to FIG. 10, which is not employed in the on-chassis topology because no plug or unplug event occurs and the peripheral is permanently connected.

In this example, the audio bus controller and the audio bus device are disposed on a common circuit board, and the at least one signal pair is routed between the audio bus controller and the audio bus device by traces on the common circuit board through USB Type-C pin assignments. The signal path from the SoundWire Manager in the SoC Die 1110 to the SoundWire peripheral 1137 traverses the Phy Interface Control Adapter 1132, the Flexible I/O Adapter 1134, and the USB Phy 1135 of the IOE Die 1130, and continues via board traces on the 2 Tx+/− and 2 Rx+/− pairs to the signal converter 1136 and the SoundWire peripheral 1137, all within the platform 1100. In this way, existing USB physical-layer hardware and board routing designed for USB Type-C connectivity may be reused for on-chassis SoundWire audio bus communication without requiring a physical USB Type-C cable or USB PD negotiation over the CC channel.

The on-chassis topology illustrated in FIG. 11 is applicable to SWI3S single-ended communication in the same manner, with the SoundWire Manager of the SoC Die 1110 replaced by a SWI3S Manager and the SoundWire peripheral 1137 replaced by a SWI3S peripheral. In the SWI3S single-ended variant, the signal path and the signal converter 1136 operate in the same manner as described for the SoundWire single-ended embodiment, with the clock and one data signal of the SWI3S single-ended physical layer routed through the USB Phy 1135 and the board traces to the signal converter 1136 and the SWI3S peripheral. The register-based capability detection by the IOM 1133 proceeds in the same manner, with the SWI3S peripheral's registers indicating the SWI3S protocol type and supported signaling configuration to the IOM 1133.

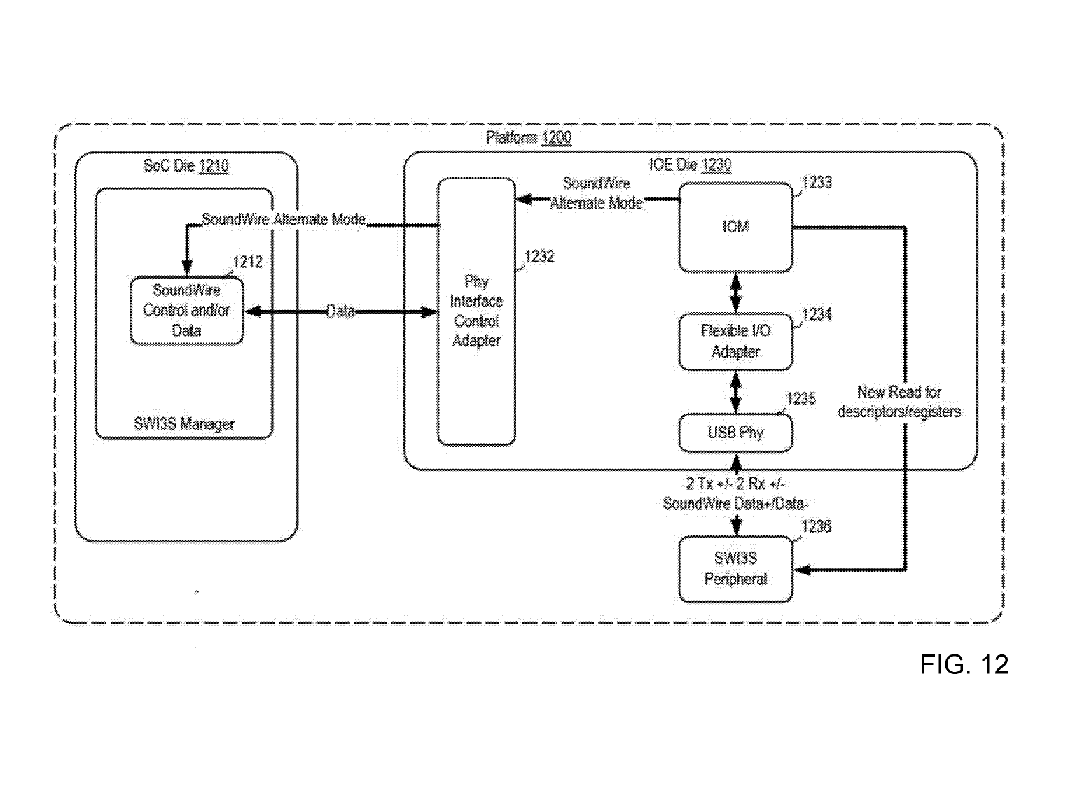

FIG. 12 illustrates an example on-chassis hard-wired connection for SWI3S differential low-voltage communication within a platform 1200, wherein the audio bus peripheral circuit is disposed on the same platform board as the host apparatus and is hard-wired to USB Type-C signal pins by traces on the common circuit board. The platform 1200 includes a system-on-chip die (SoC Die) 1210 including the audio bus controller and associated SoundWire Alternate Mode logic, and an I/O expansion die (IOE Die) 1230 including the management controller, the flexible I/O adapter, and the USB physical-layer transceiver. In an example, the SoC Die 1210 may correspond to the host apparatus 310 as described herein and the IOE die 1230 may correspond to the peripheral apparatus 330 as described herein. A SWI3S peripheral 1236, acting as the audio bus peripheral circuit in this embodiment, may be disposed on the platform board outside the IOE Die 1230 and may be connected to the IOE Die 1230 by board traces carrying SWI3S differential Data+/Data− signals routed through USB Type-C pin assignments. The architecture of the platform 1200 is structurally analogous to that of the platform 1100 described with respect to FIG. 11, with two distinctions: the audio bus controller is a SWI3S Manager rather than a SoundWire Manager, and no signal converter is present between the USB physical-layer transceiver and the SWI3S peripheral 1236, reflecting the native differential compatibility of the SWI3S differential low-voltage physical layer with the differential signal pairs of the USB Type-C interface.

The SoC Die 1210 include the audio bus controller, implemented in this embodiment as a SWI3S Manager, together with a SoundWire Control and/or Data block 1212 and SoundWire Alternate Mode logic. The SWI3S Manager generates differential SWI3S Data+/Data− signals for transmission to the SWI3S peripheral 1236 and receives differential SWI3S Data+/Data− signals from the SWI3S peripheral 1236. The SoundWire Control and/or Data block 1212 is coupled to a Phy Interface Control Adapter 1232 disposed within the IOE Die 1230, and communicates SWI3S control and data signals to the Phy Interface Control Adapter 1232 via a data path between the SoC Die 1210 and the IOE Die 1230. The SoundWire Alternate Mode logic within the SoC Die 1210 coordinates with the SoundWire Alternate Mode logic within the IOE Die 1230 to establish and maintain the SoundWire Alternate Mode configuration for the on-chassis SWI3S differential connection.

The IOE Die 1230 includes an IOM 1233, a Flexible I/O Adapter 1234, and a USB physical-layer transceiver (USB Phy) 1235. The Phy Interface Control Adapter 1232 is coupled between the SoC Die 1210 and the Flexible I/O Adapter 1234, routing SWI3S differential data signals from the SWI3S Manager of the SoC Die 1210 through the IOE Die 1230 to the USB Phy 1235. The Flexible I/O Adapter 1234 is coupled between the Phy Interface Control Adapter 1232 and the USB Phy 1235, and provides the configurable signal routing within the IOE Die 1230 that allocates USB Phy pin assignments to SWI3S differential audio bus communication. The USB Phy 1235 provides the physical-layer transmit and receive differential pairs, designated 2 Tx+/− and 2 Rx+/−, through which the SWI3S Data+/Data− signals are carried on the board traces directly to the SWI3S peripheral 1236. No signal converter is interposed between the USB Phy 1235 and the SWI3S peripheral 1236, because the SWI3S differential low-voltage signals output by the USB Phy 1235 on the 2 Tx+/− and 2 Rx+/− board traces are natively differential and are directly compatible with the differential input of the SWI3S peripheral 1236. The SWI3S peripheral 1236 receives the differential SWI3S Data+/Data− signals directly from the board traces and communicates audio data to and from the SWI3S Manager of the SoC Die 1210 via this signal path.

The IOM 1233 may act as the management controller and may be configured to detect the audio bus capabilities of the SWI3S peripheral 1236 by performing a new register read for descriptors or registers of the SWI3S peripheral 1236 through a USB-specific request and response mechanism over the USB Type-C pin interface, as indicated in FIG. 12. The registers of the SWI3S peripheral 1236 store information indicative of the audio bus capabilities of the audio bus peripheral circuit, which may further include the SWI3S protocol type, the differential low-voltage physical layer supported, and the supported signaling configuration. The IOM 1233 reads these registers and communicates the detected capabilities to the SWI3S Manager of the SoC Die 1210 via the SoundWire Alternate Mode logic, enabling the SWI3S Manager to configure the audio bus communication path for the on-chassis differential connection. As with the on-chassis SoundWire single-ended embodiment described with respect to FIG. 11, the register-based discovery mechanism replaces USB PD negotiation, which is not employed in the on-chassis topology.

In this embodiment, the audio bus protocol is a differential protocol, and the audio bus controller is configured to transmit and receive differential data signals on the at least one signal pair routed as board traces between the SoC Die 1210 and the SWI3S peripheral 1236. The audio bus peripheral circuit is correspondingly configured to transmit and receive differential data signals on the at least one signal pair. The audio bus controller and the audio bus device are disposed on a common circuit board, and the at least one signal pair is routed between the audio bus controller and the audio bus device by traces on the common circuit board through USB Type-C pin assignments, without a physical USB Type-C cable. The absence of a signal converter in the signal path, in contrast to the on-chassis SoundWire single-ended embodiment of FIG. 11, reflects the direct compatibility of the SWI3S differential low-voltage physical layer with the differential pairs of the USB Type-C interface and the board traces carrying those signals within the platform 1200.

The on-chassis SWI3S differential topology illustrated in FIG. 12 may be extended to support multiple independent SWI3S differential low-voltage buses by routing additional differential pairs from the USB Phy 1235 to additional SWI3S peripherals on the platform board. In such an extension, a further audio bus controller on the host side communicates with a further audio bus peripheral circuit on the peripheral side on a further signal pair routed as a further set of board traces, independently of the first SWI3S differential bus. This extension allows a single platform to support multiple simultaneous SWI3S differential low-voltage audio bus links over the USB Type-C pin assignments of the IOE Die 1230, reusing the same USB physical-layer hardware and board routing for each additional bus.

A single USB Type-C connector may support more than one independent audio bus simultaneously by mapping different audio bus instances to different sets of signal pairs of the USB Type-C interface. In such an example, the host apparatus further includes a further audio bus controller configured to transmit and receive signals according to a further audio bus protocol on a further signal pair of the plurality of signal pins, the further audio bus controller communicating with a further audio bus device independently of the audio bus controller. Correspondingly, the peripheral apparatus may further include a further audio bus peripheral circuit configured to transmit and receive signals according to a further audio bus protocol on a further signal pair of the plurality of signal pins, the further audio bus peripheral circuit communicating with the host apparatus independently of the audio bus peripheral circuit.

As one example, a first SoundWire bus may be mapped to the Tx+/− signal pairs while a second SWI3S single-ended bus is mapped to the D+/D− signal pair, with both buses operating concurrently over the same USB Type-C connection. As a further example, a first SWI3S differential low-voltage bus may be mapped to the TX1+/TX1− pair while a second SWI3S differential low-voltage bus is mapped to the TX2+/TX2− pair, enabling two independent SWI3S differential buses over a single USB Type-C connector. The multi-bus arrangement is applicable to both the external connection topology, in which the signal pair allocation for each bus is established during USB PD negotiation, and the on-chassis topology, in which the allocation is established through register-based capability discovery.

Signal pairs of the USB Type-C interface not allocated to the audio bus controller or to any further audio bus controller remain available for standard USB data communication. The host apparatus may further include a USB controller coupled to one or more further signal pairs of the plurality of signal pins not allocated to the audio bus controller, wherein the USB controller is configured to maintain USB data communication through the USB Type-C interface concurrently with audio bus communication by the audio bus controller. Correspondingly, the peripheral apparatus may further include a USB controller coupled to one or more further signal pairs of the plurality of signal pins not allocated to the audio bus peripheral circuit, wherein the USB controller is configured to maintain USB data communication through the USB Type-C interface concurrently with audio bus communication by the audio bus peripheral circuit.

As one example, a SWI3S differential low-voltage bus may be allocated to the Tx+/− and Rx+/− signal pairs, while the D+/D− signal pair remains allocated to the USB controller for USB 2.0 data communication, enabling simultaneous SWI3S audio bus traffic and USB data traffic through the same USB Type-C connection. In the external connection topology, the coexistence of audio bus and USB data communication is managed by the multiplexer configuration established upon entry into the SoundWire Alternate Mode. In the on-chassis topology, the coexistence is managed by the Flexible I/O Adapter configuration established upon register-based capability discovery by the management controller.

The audio bus peripheral circuit of the peripheral apparatus may include at least one of an audio codec, an audio amplifier, or a microphone array. An audio codec is a circuit that encodes and decodes audio data, converting between digital audio representations and analogue audio signals suitable for playback through speakers or headphones, or capturing audio from microphones. An audio amplifier is a circuit that drives speakers or headphones at sufficient power levels for audio output, receiving digital audio data from the audio bus peripheral circuit and converting it to an amplified analogue signal. A microphone array is a circuit including a plurality of microphone elements arranged to capture audio from multiple directions, providing multi-channel digital audio data to the audio bus controller via the audio bus peripheral circuit. Combinations of these peripheral circuit types may be present within a single peripheral apparatus; for example, a peripheral apparatus may include both an audio codec and an audio amplifier to provide a complete audio output subsystem, or both a microphone array and an audio codec to provide a complete audio capture subsystem, all accessible to the audio bus controller over the USB Type-C interface.

The peripheral apparatus may take a variety of form factors depending on the intended application. In one example, the peripheral apparatus is a wearable audio device, such as wireless earbuds, an over-ear headset, a headband-mounted audio device, or a hearing aid, in which the audio bus peripheral circuit provides audio codec or amplifier functionality for audio playback and capture in a compact, body-worn form factor. In another example, the peripheral apparatus is an audio accessory, such as an external speaker, a USB Type-C audio dongle, an augmented reality or virtual reality headset, or a SWI3S debugger used for development and testing of SWI3S audio systems. The host apparatus may correspondingly take the form of a smartphone, laptop, tablet, desktop computing system, or any platform including a processor or SoC, a USB Type-C interface, and an audio bus controller, as described herein. The combination of host apparatus and peripheral apparatus form factors described in this section enables audio bus communication over USB Type-C across a wide range of platform and accessory configurations.

In various examples, the audio bus protocol includes a MIPI SoundWire protocol or a MIPI SoundWire I3S (SWI3S) protocol. The SoundWire Alternate Mode as defined herein accommodates both the SoundWire protocol and the SWI3S protocol within a unified negotiation and configuration framework; the specific audio bus protocol type is identified during the Discover Modes phase of USB PD negotiation in the external connection topology, or through register reads performed by the management controller in the on-chassis topology, as described herein. In external connection examples employing the SoundWire protocol, the audio bus controller is configured to manage SoundWire protocol transactions including a clock signal and between one and seven data signals on respective signal pairs, and the audio bus peripheral circuit is configured to respond to SoundWire protocol transactions accordingly. In external connection and on-chassis examples employing the SWI3S protocol, the audio bus controller is configured to manage SWI3S protocol transactions according to either the single-ended or the differential low-voltage physical layer, as established during negotiation or discovery, and the audio bus peripheral circuit is configured to respond accordingly. The examples described herein are not limited to the SoundWire and SWI3S protocols and may be applied to other audio bus protocols capable of being mapped to signal pairs of a USB Type-C interface.

In a further example, a system includes a host apparatus as described with respect to any of the host-side examples herein and an audio bus device as described with respect to any of the peripheral-side examples herein, coupled via a USB Type-C interface. The system may be configured as an external connection, in which the host apparatus and the audio bus device are coupled by a USB Type-C cable between their respective externally exposed USB Type-C ports, or as an on-chassis connection, in which the host apparatus and the audio bus device are disposed on a common circuit board and the signal pairs of the USB Type-C interface are routed between them by traces on the common circuit board. In either configuration, the host apparatus and the audio bus device cooperate to implement audio bus communication over the signal pairs of the USB Type-C interface, with the host-side apparatus managing the audio bus protocol as described herein and the peripheral-side apparatus responding to audio bus protocol communication as described herein. The system may support one or more audio bus links simultaneously over the same USB Type-C interface, together with concurrent USB data communication on signal pairs not allocated to audio bus use.

The examples described herein enable a range of use cases that benefit from the routing of native audio bus protocol signals over a USB Type-C interface. These include connecting SoundWire and SWI3S audio peripheral devices to a host platform over a USB Type-C cable link, connecting external SWI3S audio systems such as augmented reality or virtual reality headsets to a host platform via USB Type-C, connecting SWI3S debuggers to a host platform over a USB Type-C connection for development and testing purposes, and reusing existing USB Type-C board routing and USB physical-layer hardware for on-chassis audio bus interconnects within a computing platform. In the on-chassis topology, the examples described herein enable existing and proven USB Type-C board routing to be reused for SWI3S audio bus communication without requiring changes to the board or silicon routing of the platform, enabling platforms to support the SWI3S audio interconnect by leveraging infrastructure already present for USB Type-C connectivity.

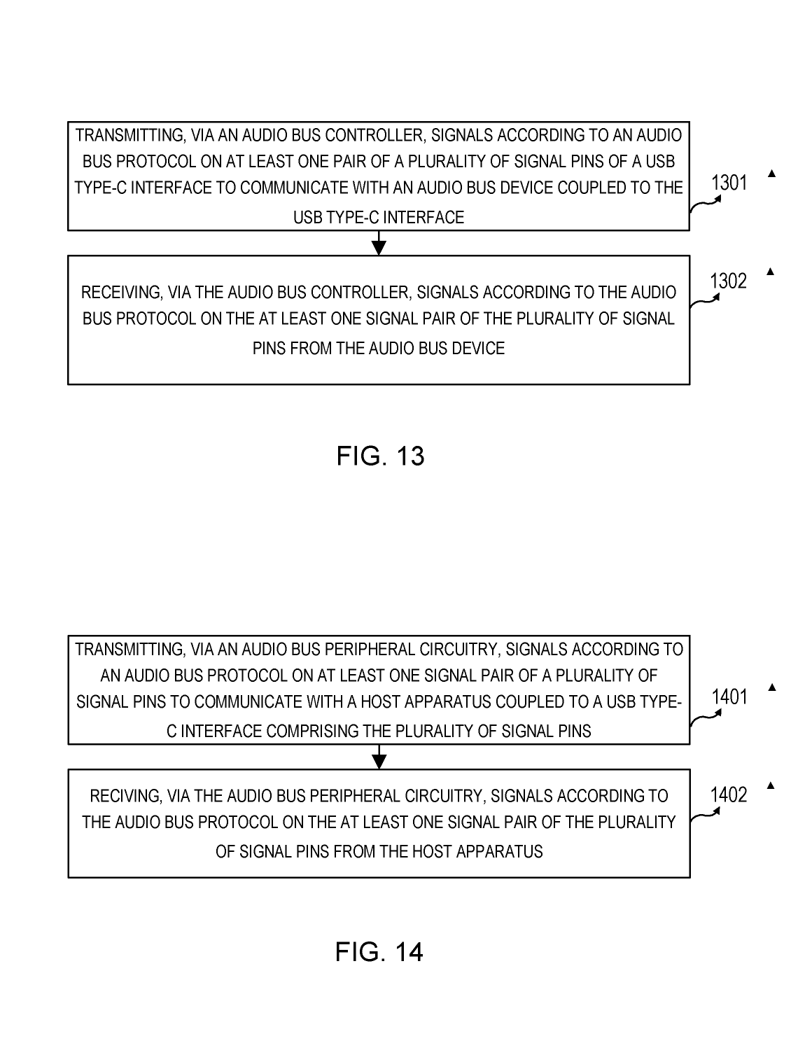

FIG. 13 shows an example of a method. The method may include: transmitting 1301, via an audio bus controller, signals according to an audio bus protocol on at least one signal pair of a plurality of signal pins of a USB Type-C interface to communicate with an audio bus device coupled to the USB Type-C interface; and receiving 1302, via the audio bus controller, signals according to the audio bus protocol on the at least one signal pair of the plurality of signal pins from the audio bus device.

FIG. 14 shows an example of a method. The method may include transmitting 1401, via an audio bus peripheral circuit, signals according to an audio bus protocol on at least one signal pair of a plurality of signal pins to communicate with a host apparatus coupled to a USB Type-C interface including the plurality of signal pins; and receiving 1402, via the audio bus peripheral circuit, signals according to the audio bus protocol on the at least one signal pair of the plurality of signal pins from the host apparatus.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more."

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of an apparatus including: a USB Type-C interface including a plurality of signal pins; and an audio bus controller coupled to the USB Type-C interface, wherein the audio bus controller is configured to: transmit and receive signals according to an audio bus protocol on at least one signal pair of the plurality of signal pins to communicate with an audio bus device coupled to the USB Type-C interface.

Example 2 may include the subject matter of example 1, may further include a signal converter coupled between the audio bus controller and the at least one signal pair, wherein the signal converter is configured to convert between single-ended signals of the audio bus controller and differential signals on the at least one signal pair.

Example 3 may include the subject matter of any one of examples 1 to 2, may further include a multiplexer coupled between the plurality of signal pins and the audio bus controller, wherein the multiplexer is configurable to selectively route the at least one signal pair to the audio bus controller.

Example 4 may include the subject matter of example 3, may further include a power delivery controller configured to: negotiate an alternate mode for audio bus communication with the audio bus device via USB Power Delivery signaling through the USB Type-C interface; and upon successful negotiation, to configure the multiplexer to route the at least one signal pair to the audio bus controller, wherein preferably the power delivery controller is further configured to, upon successful negotiation, configure the signal converter for at least one of: a clock frequency, a signaling rate, or a data line allocation for the audio bus communication.

Example 5 may include the subject matter of example 4, wherein the power delivery controller is further configured to provide, upon successful negotiation, an indication to a host processor that the audio bus device is connected to the USB Type-C interface in the alternate mode to cause the host processor to initiate loading of software for audio bus communication with the audio bus device.

Example 6 may include the subject matter of any one of examples 1 to 5, may further include a management controller configured to detect audio bus capabilities of the audio bus device by accessing one or more registers of the audio bus device through the USB Type-C interface.

Example 7 may include the subject matter of example 6, wherein the audio bus controller and the audio bus device are disposed on a common circuit board, and wherein the at least one signal pair is routed between the audio bus controller and the audio bus device by traces on the common circuit board.

Example 8 may include the subject matter of any one of examples 1 to 7, wherein the audio bus protocol is a single-ended protocol, and the audio bus controller is configured to transmit a clock signal and at least one data signal on respective signal pairs of the plurality of signal pins.

Example 9 may include the subject matter of any one of examples 1 to 7, wherein the audio bus protocol is a differential protocol, and the audio bus controller is configured to transmit and receive differential data signals on the at least one signal pair.

Example 10 may include the subject matter of any one of examples 1 to 9, wherein the at least one signal pair includes one or more of: a transmit differential pair, a receive differential pair, a USB 2.0 data pair, or a sideband use pair of the USB Type-C interface.

Example 11 may include the subject matter of any one of examples 1 to 10, may further include a further audio bus controller configured to transmit and receive signals according to a further audio bus protocol on a further signal pair of the plurality of signal pins, the further audio bus controller communicating with a further audio bus device independently of the audio bus controller.

Example 12 may include the subject matter of any one of examples 1 to 11, wherein the audio bus protocol includes a MIPI SoundWire protocol or a MIPI SoundWire I3S (SWI3S) protocol.

Example 13 may include the subject matter of any one of examples 1 to 12, may further include a USB controller coupled to one or more further signal pairs of the plurality of signal pins not allocated to the audio bus controller, wherein the USB controller is configured to maintain USB data communication through the USB Type-C interface concurrently with audio bus communication by the audio bus controller.

Example 14 may include the subject matter of an apparatus including: a USB Type-C interface including a plurality of signal pins; and an audio bus peripheral circuit configured to transmit and receive signals according to an audio bus protocol on at least one signal pair of the plurality of signal pins to communicate with a host apparatus coupled to the USB Type-C interface.

Example 15 may include the subject matter of example 14, may further include a signal converter coupled between the audio bus peripheral circuit and the at least one signal pair, the signal converter configured to convert between single-ended signals of the audio bus peripheral circuit and differential signals on the at least one signal pair.

Example 16 may include the subject matter of any one of examples 14 to 15, may further include a power delivery controller configured to respond to USB Power Delivery signaling from the host apparatus to negotiate an alternate mode for audio bus communication through the USB Type-C interface.

Example 17 may include the subject matter of example 16, wherein, upon successful negotiation of the alternate mode, the power delivery controller is configured to cause the at least one signal pair to be routed to the audio bus peripheral circuit.

Example 18 may include the subject matter of any one of examples 16 to 17, wherein the power delivery controller is further configured to indicate to the host apparatus one or more of: an audio bus protocol type, a signaling rate, or a number of data lanes supported by the audio bus peripheral circuit.

Example 19 may include the subject matter of any one of examples 14 to 18, wherein the audio bus protocol is a single-ended protocol, and the audio bus peripheral circuit is configured to transmit and receive a clock signal and at least one data signal on respective signal pairs of the plurality of signal pins.

Example 20 may include the subject matter of any one of examples 14 to 19, wherein the audio bus protocol is a differential protocol, and the audio bus peripheral circuit is configured to transmit and receive differential data signals on the at least one signal pair.

Example 21 may include the subject matter of any one of examples 14 to 20, wherein the at least one signal pair includes one or more of: a transmit differential pair, a receive differential pair, a USB 2.0 data pair, or a sideband use pair of the USB Type-C interface.

Example 22 may include the subject matter of any one of examples 14 to 21, wherein the audio bus peripheral circuit includes at least one of: an audio codec, an audio amplifier, or a microphone array.

Example 23 may include the subject matter of any one of examples 14 to 22, may further include a USB controller coupled to one or more further signal pairs of the plurality of signal pins not allocated to the audio bus peripheral circuit, wherein the USB controller is configured to maintain USB data communication through the USB Type-C interface concurrently with audio bus communication by the audio bus peripheral circuit.

Example 24 may include the subject matter of any one of examples 14 to 23, wherein the apparatus is a wearable audio device or an audio accessory.

Example 25 may include the subject matter of any one of examples 14 to 24, may further include a further audio bus peripheral circuit configured to transmit and receive signals according to a further audio bus protocol on a further signal pair of the plurality of signal pins, the further audio bus peripheral circuit communicating with the host apparatus independently of the audio bus peripheral circuit.

Example 26 may include the subject matter of any one of examples 14 to 25, may further include one or more registers accessible by the host apparatus through the USB Type-C interface, the one or more registers storing information indicative of audio bus capabilities of the audio bus peripheral circuit.

Example 27 may include the subject matter of any one of examples 14 to 26, wherein the audio bus protocol includes a MIPI SoundWire protocol or a MIPI SoundWire I3S (SWI3S) protocol.

Example 28 may include the subject matter of a method including: transmitting, via an audio bus controller, signals according to an audio bus protocol on at least one signal pair of a plurality of signal pins of a USB Type-C interface to communicate with an audio bus device coupled to the USB Type-C interface; and receiving, via the audio bus controller, signals according to the audio bus protocol on the at least one signal pair of the plurality of signal pins from the audio bus device.

Example 29 may include the subject matter of example 28, may further include converting, via a signal converter coupled between the audio bus controller and the at least one signal pair, between single-ended signals of the audio bus controller and differential signals on the at least one signal pair.

Example 30 may include the subject matter of any one of examples 28 to 29, may further include selectively routing, via a multiplexer coupled between the plurality of signal pins and the audio bus controller, the at least one signal pair to the audio bus controller.

Example 31 may include the subject matter of example 30, may further include negotiating, via a power delivery controller, an alternate mode for audio bus communication with the audio bus device via USB Power Delivery signaling through the USB Type-C interface; and upon successful negotiation, configuring the multiplexer to route the at least one signal pair to the audio bus controller, wherein preferably the power delivery controller is further configured to, upon successful negotiation, configure the signal converter for at least one of: a clock frequency, a signaling rate, or a data line allocation for the audio bus communication.

Example 32 may include the subject matter of example 31, may further include providing, via the power delivery controller upon successful negotiation, an indication to a host processor that the audio bus device is connected to the USB Type-C interface in the alternate mode to cause the host processor to initiate loading of software for audio bus communication with the audio bus device.

Example 33 may include the subject matter of any one of examples 27 to 32, may further include detecting, via a management controller, audio bus capabilities of the audio bus device by accessing one or more registers of the audio bus device through the USB Type-C interface.

Example 34 may include the subject matter of example 33, wherein the audio bus controller and the audio bus device are disposed on a common circuit board, and wherein the at least one signal pair is routed between the audio bus controller and the audio bus device by traces on the common circuit board.

Example 35 may include the subject matter of any one of examples 28 to 34, wherein the audio bus protocol is a single-ended protocol, and the method further includes transmitting, via the audio bus controller, a clock signal and at least one data signal on respective signal pairs of the plurality of signal pins.

Example 36 may include the subject matter of any one of examples 28 to 34, wherein the audio bus protocol is a differential protocol, and the method further includes transmitting and receiving differential data signals on the at least one signal pair.

Example 37 may include the subject matter of any one of examples 28 to 36, wherein the at least one signal pair includes one or more of: a transmit differential pair, a receive differential pair, a USB 2.0 data pair, or a sideband use pair of the USB Type-C interface.

Example 38 may include the subject matter of any one of examples 28 to 37, may further include transmitting and receiving, via a further audio bus controller, signals according to a further audio bus protocol on a further signal pair of the plurality of signal pins, the further audio bus controller communicating with a further audio bus device independently of the audio bus controller.

Example 39 may include the subject matter of any one of examples 28 to 38, wherein the audio bus protocol includes a MIPI SoundWire protocol or a MIPI SoundWire I3S (SWI3S) protocol.

Example 40 may include the subject matter of any one of examples 28 to 39, may further include a USB controller coupled to one or more further signal pairs of the plurality of signal pins not allocated to the audio bus controller, wherein the method further includes, maintaining, by the USB controller, USB data communication through the USB Type-C interface concurrently with audio bus communication by the audio bus controller.

Example 41 may include the subject matter of a method including: transmitting, via an audio bus peripheral circuit, signals according to an audio bus protocol on at least one signal pair of a plurality of signal pins to communicate with a host apparatus coupled to a USB Type-C interface including the plurality of signal pins; and receiving, via the audio bus peripheral circuit, signals according to the audio bus protocol on the at least one signal pair of the plurality of signal pins from the host apparatus.

Example 42 may include the subject matter of example 41, may further include converting, via a signal converter coupled between the audio bus peripheral circuit and the at least one signal pair, between single-ended signals of the audio bus peripheral circuit and differential signals on the at least one signal pair.

Example 43 may include the subject matter of any one of examples 41 to 42, may further include responding, via a power delivery controller, to USB Power Delivery signaling from the host apparatus to negotiate an alternate mode for audio bus communication through the USB Type-C interface.

Example 44 may include the subject matter of example 43, may further include, upon successful negotiation of the alternate mode, causing, via the power delivery controller, the at least one signal pair to be routed to the audio bus peripheral circuit.

Example 45 may include the subject matter of any one of examples 43 to 44, may further include indicating, via the power delivery controller, to the host apparatus one or more of: an audio bus protocol type, a signaling rate, or a number of data lanes supported by the audio bus peripheral circuit.

Example 46 may include the subject matter of any one of examples 41 to 45, wherein the audio bus protocol is a single-ended protocol, and the method further includes transmitting and receiving, via the audio bus peripheral circuit, a clock signal and at least one data signal on respective signal pairs of the plurality of signal pins.

Example 47 may include the subject matter of any one of examples 41 to 46, wherein the audio bus protocol is a differential protocol, and the method further includes transmitting and receiving, via the audio bus peripheral circuit, differential data signals on the at least one signal pair.

Example 48 may include the subject matter of any one of examples 41 to 47, wherein the at least one signal pair includes one or more of: a transmit differential pair, a receive differential pair, a USB 2.0 data pair, or a sideband use pair of the USB Type-C interface.

Example 49 may include the subject matter of any one of examples 41 to 48, wherein the audio bus peripheral circuit includes at least one of: an audio codec, an audio amplifier, or a microphone array.

Example 50 may include the subject matter of any one of examples 41 to 49, may further include maintaining, via a USB controller coupled to one or more further signal pairs of the plurality of signal pins not allocated to the audio bus peripheral circuit, USB data communication through the USB Type-C interface concurrently with audio bus communication by the audio bus peripheral circuit.

Example 51 may include the subject matter of any one of examples 41 to 50, wherein the method is used by a wearable audio device or an audio accessory.

Example 52 may include the subject matter of any one of examples 41 to 51, may further include transmitting and receiving, via a further audio bus peripheral circuit, signals according to a further audio bus protocol on a further signal pair of the plurality of signal pins, the further audio bus peripheral circuit communicating with the host apparatus independently of the audio bus peripheral circuit.

Example 53 may include the subject matter of any one of examples 41 to 52, may further include one or more registers accessible by the host apparatus through the USB Type-C interface, the one or more registers storing information indicative of audio bus capabilities of the audio bus peripheral circuit.

Example 54 may include the subject matter of any one of examples 41 to 53, wherein the audio bus protocol includes a MIPI SoundWire protocol or a MIPI SoundWire I3S (SWI3S) protocol.

Example 57 may include an apparatus including means to perform the methods of any one of examples 28 to 56.

What is claimed is:

1. An apparatus comprising:
a USB Type-C interface comprising a plurality of signal pins; and
an audio bus controller coupled to the USB Type-C interface, wherein the audio bus controller is configured to:
transmit and receive signals according to an audio bus protocol on at least one signal pair of the plurality of signal pins to communicate with an audio bus device coupled to the USB Type-C interface.

2. The apparatus of claim 1, further comprising a signal converter coupled between the audio bus controller and the at least one signal pair, wherein the signal converter is configured to convert between single-ended signals of the audio bus controller and differential signals on the at least one signal pair.

3. The apparatus of claim 1, further comprising a multiplexer coupled between the plurality of signal pins and the audio bus controller, wherein the multiplexer is configurable to selectively route the at least one signal pair to the audio bus controller.

4. The apparatus of claim 3, further comprising a power delivery controller configured to:
negotiate an alternate mode for audio bus communication with the audio bus device via USB Power Delivery signaling through the USB Type-C interface; and
upon successful negotiation, to configure the multiplexer to route the at least one signal pair to the audio bus controller.

5. The apparatus of claim 4, wherein the power delivery controller is further configured to provide, upon successful negotiation, an indication to a host processor that the audio bus device is connected to the USB Type-C interface in the alternate mode to cause the host processor to initiate loading of software for audio bus communication with the audio bus device.

6. The apparatus of claim 1, further comprising a management controller configured to detect audio bus capabilities of the audio bus device by accessing one or more registers of the audio bus device through the USB Type-C interface.

7. The apparatus of claim 6, wherein the audio bus controller and the audio bus device are disposed on a common circuit board, and wherein the at least one signal pair is routed between the audio bus controller and the audio bus device by traces on the common circuit board.

8. The apparatus of claim 1, wherein the audio bus protocol is a single-ended protocol, and the audio bus controller is configured to transmit a clock signal and at least one data signal on respective signal pairs of the plurality of signal pins.

9. The apparatus of claim 1, wherein the audio bus protocol is a differential protocol, and the audio bus controller is configured to transmit and receive differential data signals on the at least one signal pair.

10. The apparatus of claim 1, wherein the at least one signal pair comprises one or more of: a transmit differential pair, a receive differential pair, a USB 2.0 data pair, or a sideband use pair of the USB Type-C interface.

11. The apparatus of claim 1, wherein the audio bus protocol comprises a MIPI SoundWire protocol or a MIPI SoundWire I3S (SWI3S) protocol.

12. The apparatus of claim 1, further comprising a USB controller coupled to one or more further signal pairs of the plurality of signal pins not allocated to the audio bus controller, wherein the USB controller is configured to maintain USB data communication through the USB Type-C interface concurrently with audio bus communication by the audio bus controller.

13. An apparatus comprising:
a USB Type-C interface comprising a plurality of signal pins; and
an audio bus peripheral circuit configured to transmit and receive signals according to an audio bus protocol on at least one signal pair of the plurality of signal pins to communicate with a host apparatus coupled to the USB Type-C interface.

14. The apparatus of claim 13, further comprising a power delivery controller configured to respond to USB Power Delivery signaling from the host apparatus to negotiate an alternate mode for audio bus communication through the USB Type-C interface.

15. The apparatus of claim 14, wherein the power delivery controller is further configured to indicate to the host apparatus one or more of: an audio bus protocol type, a signaling rate, or a number of data lanes supported by the audio bus peripheral circuit.

16. The apparatus of claim 13, further comprising a USB controller coupled to one or more further signal pairs of the plurality of signal pins not allocated to the audio bus peripheral circuit, wherein the USB controller is configured to maintain USB data communication through the USB Type-C interface concurrently with audio bus communication by the audio bus peripheral circuit.

17. The apparatus of claim 13, further comprising one or more registers accessible by the host apparatus through the USB Type-C interface, the one or more registers storing information indicative of audio bus capabilities of the audio bus peripheral circuit.

18. The apparatus of claim 13, wherein the audio bus protocol comprises a MIPI SoundWire protocol or a MIPI SoundWire I3S (SWI3S) protocol.

19. A method comprising:
transmitting, via an audio bus controller, signals according to an audio bus protocol on at least one signal pair of a plurality of signal pins of a USB Type-C interface to communicate with an audio bus device coupled to the USB Type-C interface; and
receiving, via the audio bus controller, signals according to the audio bus protocol on the at least one signal pair of the plurality of signal pins from the audio bus device.

20. The method of claim 19, further comprising converting, via a signal converter coupled between the audio bus controller and the at least one signal pair, between single-ended signals of the audio bus controller and differential signals on the at least one signal pair.
